(19) United States
(12) Patent Application Publication
(10) Pub. No.: US 2025/0056359 A1
(43) Pub. Date: Feb. 13, 2025

(54) METHOD AND APPARATUS FOR HANDOVER ASSOCIATED WITH USAGE OF A PDU SET

(71) Applicant: Samsung Electronics Co., Ltd., Suwon-si (KR)

(72) Inventors: Hong WANG, Beijing (CN); Weiwei WANG, Beijing (CN); Lixiang XU, Beijing (CN)

(21) Appl. No.: 18/799,461

(22) Filed: Aug. 9, 2024

(30) Foreign Application Priority Data
Aug. 9, 2023 (CN) 202311000787.7

(51) Int. Cl. H04W 36/30; H04L 5/00; H04W 36/32

(52) U.S. Cl. CPC H04W 36/30; H04L 5/0053; H04W 36/32

(57) ABSTRACT

The disclosure relates to a 5G or 6G communication system for supporting a higher data transmission rate. A method performed by a second node in a communication system is provided. The method includes transmitting, to a third node, a first message including first indication information for indicating whether the second node supports handling of a packet data unit (PDU) set of an extended reality (XR) service and receiving, from the third node, a second message, wherein if the first indication information indicates that the second node supports the handling of the PDU set of the XR service, the second message includes XR service configuration information.

### CROSS-REFERENCE TO RELATED APPLICATION(S)

This application is based on and claims priority under 35 U.S.C. § 119(a) of a Chinese patent application number 202311000787.7, filed on Aug. 9, 2023, in the Chinese Intellectual Property Office, the disclosure of which is incorporated by reference herein in its entirety.

### BACKGROUND

### 1. Field

The disclosure relates to the field of communication. More particularly, the disclosure relates to a first or second or third node and methods performed by the same.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

In order to meet an increasing demand for wireless data communication services since a deployment of fourth generation (4G) communication system, efforts have been made to develop an improved fifth generation (5G) or pre-5G communication system. Therefore, the 5G or pre-5G communication system is also referred to as “beyond 4G network” or “post long term evolution (LTE) system”.

Wireless communication is one of the most successful innovations in modern history. Recently, a number of subscribers of wireless communication services has exceeded 5 billion, and it continues growing rapidly. With the increasing popularity of smart phones and other mobile data devices (such as tablet computers, notebook computers, netbooks, e-book readers and machine-type devices) in consumers and enterprises, a demand for wireless data services is growing rapidly. In order to meet rapid growth of mobile data services and support new applications and deployments, it is very important to improve efficiency and coverage of wireless interfaces.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a first or second or third node and methods performed by the same.

Additional aspects will be set forth in part in the description which follows and, in part, will be apparent from the description, or may be learned by practice of the presented embodiments.

In accordance with an aspect of the disclosure, a method performed by a first node in a wireless communication system, the method including: transmitting, to a second node, a handover request message comprising first information on a protocol data unit (PDU) set associated with quality of service (QoS) parameters; receiving, from the second node, a handover request acknowledge message; identifying whether second information indicating support of a PDU set based handling is included in the handover acknowledge message; and in case that the second information indicating the support of the PDU set based handling is included in the handover acknowledge message, generating a data to be forwarded including third information on the PDU set.

According to the method performed by the first node in the communication system provided by the disclosure, wherein the first information comprises PDU set QoS parameters information element, wherein the second information comprises PDU set based handling indicator information element, and wherein the third information comprises PDU set information container.

According to the method performed by the first node in the communication system provided by the disclosure, further comprising: transmitting, to the second node, the data with the third information on the PDU set.

According to the method performed by the first node in the communication system provided by the disclosure, wherein the second information is transmitted by the second node to an access and mobility management function (AMF).

In accordance with an aspect of the disclosure, a method performed by a second node in a wireless communication system, the method including: receiving, from a first node, a handover request message comprising first information on a protocol data unit (PDU) set associated with quality of service (QoS) parameters; and transmitting, to the first node, a handover request acknowledge message; wherein, in case that second information indicating support of a PDU set based handling is included in the handover acknowledge message, third information on the PDU set is included in a data to be forwarded by the first node.

In accordance with an aspect of the disclosure, a first node in a wireless communication system, the first node including: a transceiver; and at least one processor coupled with the transceiver and configured to: transmit, to a second node, a handover request message comprising first information on a protocol data unit (PDU) set associated with quality of service (QoS) parameters, receive, from the second node, a handover request acknowledge message, identify whether second information indicating support of a PDU set based handling is included in the handover acknowledge message, and in case that the second information indicating the support of the PDU set based handling is included in the handover acknowledge message, generate a data to be forwarded including third information on the PDU set.

In accordance with an aspect of the disclosure, a second node in a wireless communication system, the second node including: a transceiver; and at least one processor coupled with the transceiver and configured to: receive, from a first node, a handover request message comprising first information on a protocol data unit (PDU) set associated with quality of service (QoS) parameters, and transmit, to the first node, a handover request acknowledge message, wherein, in case that second information indicating support of a PDU set based handling is included in the handover acknowledge message, third information on the PDU set is included in a data to be forwarded by the first node. In accordance with an aspect of the disclosure, a method performed by a second node in a communication system is provided. The method includes transmitting, to a third node, a first message including first indication information for indicating whether the second node supports handling of a packet data unit (PDU) set of an extended reality (XR) service and receiving, from the third node, a second message, wherein if the first indication information indicates that the second node supports the handling of the PDU set of the XR service, the second message includes XR service configuration information.

According to the method performed by the second node in the communication system provided by the disclosure, wherein the method further comprises receiving, from a first node, a third message including or not including XR service configuration information corresponding to the first node, transmitting, to the first node, a fourth message including second indication information for indicating whether the second node supports the handling of the PDU set of the extended reality (XR) service.

According to the method performed by the second node in the communication system provided by the disclosure, wherein the second node is a destination base station, the third node is a session management function (SMF) or an access and mobility management function (AMF), and the first node is a source base station.

According to the method performed by the second node in the communication system provided by the disclosure, wherein the method further comprises transmitting, to a user plane of the second node, a fifth message including or not including XR service configuration information corresponding to the second node, receiving, from the user plane of the second node, a sixth message including third indication information for indicating whether the user plane of the second node supports the handling of the PDU set of XR service.

According to the method performed by the second node in the communication system provided by the disclosure, wherein the XR service configuration information includes at least one of a periodicity of XR data transferred on a quality of service (QoS) flow, time of arrival of a data burst, a duration of data survival, configuration information for jitter, an identification of a QoS flow, a type of a PDU set, an identification of a PDU set, a PDU set delay budget (PSDB) for indicating an upper limit of a delay that a PDU set may experience at user plane function (UPF) for a transmission between a user equipment (UE) and an N6 termination point, a PDU set error rate (PDER) for indicating an upper limit of a loss rate of a non-congestion related PDU set, and a PDU set integrated handling indication (PSIHI) for indicating whether an application layer needs all PDUs of a PDU set when using the PDU set all PDUs.

In accordance with another aspect of the disclosure, a method performed by a third node in a communication system is provided. The method includes receiving, from a second node, a first message including first indication information for indicating whether the second node supports handling of a packet data unit (PDU) set of extended reality (XR) service and transmitting, to the second node, a second message, wherein if the first indication information indicates that the second node supports the handling of the PDU set of the XR service, the second message includes XR service configuration information.

In accordance with another aspect of the disclosure, a method performed by a first node in a communication system is provided. The method includes transmitting, to a second node, a third message including or not including extended reality (XR) service configuration information corresponding to the first node, receiving, from the second node, a fourth message including second indication information for indicating whether the second node supports handling of a packet data unit (PDU) set of extended reality (XR) service.

According to the method performed by the first node in the communication system provided by the disclosure, wherein the method further comprises transmitting, to a user plane of the first node, a seventh message including fourth indication information for indicating whether the second node supports the handling of the PDU set of the XR service.

According to the method performed by the first node in the communication system provided by the disclosure, wherein the method further comprises transmitting, to a user equipment, a radio resource control protocol (RRC) reconfiguration request message including fifth indication information for indicating whether the second node supports the handling of the PDU set of the XR service, wherein a destination cell of the user equipment is selected based on the fifth indication information.

In accordance with another aspect of the disclosure, a method performed by a second node in a communication system is provided. The method includes receiving, from a first node, an eighth message including a sequence number of packet data unit (PDU) set (PSSN), performing corresponding operations based on the eighth message.

According to the method performed by the second node in the communication system provided by the disclosure, wherein the first node is one of a base station, a source base station, a user plane of a centralized unit of a source base station (gNB-CU-UP), a control plane of a centralized unit of a source base station (gNB-CU-CP), an access and mobility management function (AMF), a session management function (SMF), or a user plane function (UPF) and/or the second node is one of a base station, a destination base station, a destination gNB-CU-UP, a source gNB-CU-CP, a destination gNB-CU-CP, an AMF, an SMF, or a UPF.

According to the method performed by the second node in the communication system provided by the disclosure, wherein the eighth message further includes sixth indication information for indicating a PDU loss in the PDU set corresponding to the PSSN or indicating to discard a PDU in the PDU set.

According to the method performed by the second node in the communication system provided by the disclosure, wherein the eighth message is a message of the control plane or a message of the user plane.

According to the method performed by the second node in the communication system provided by the disclosure, wherein the method further comprises receiving, from a third node, a data packet, and the performing corresponding operations comprises discarding the PDUs belonging to the PDU set corresponding to the PSSN, wherein the third node is a UPF.

According to the method performed by the second node in the communication system provided by the disclosure, wherein the performing corresponding operations comprises transmitting, to a fourth node, a ninth message including the PSSN and/or seventh indication information for indicating a PDU loss in the PDU set corresponding to the PSSN or indicating to discard a PDU in the PDU set, wherein the fourth node is one of a base station, a destination base station, a destination gNB-CU-UP, a gNB-CU-CP, a destination gNB-CU-CP, an AMF, an SMF, or a UPF.

According to the method performed by the second node in the communication system provided by the disclosure, wherein the performing corresponding operations comprises not transmitting all PDUs belonging to the PDU set corresponding to the PSSN to the gNB-CU-UP, wherein the gNB-CU-UP is one of a destination gNB-CU-UP, a source gNB-CU-UP, and a gNB-CU-UP currently serving for user equipment (UE).

According to the method performed by the second node in the communication system provided by the disclosure, wherein performing corresponding operations comprises transmitting, to a fifth node, a PDU belonging to a new PDU set, which is a next PDU set of the PDU set corresponding to the PSSN, wherein, the fifth node is one of a destination base station, a destination gNB-CU-UP, or a gNB-CU-UP currently serving for UE.

In accordance with another aspect of the disclosure, a first node is provided. The first node includes a transceiver configured to transmit and receive signals with the outside and a controller configured to control the transceiver to perform the above method performed by the first node.

In accordance with another aspect of the disclosure, a second node is provided. The second node includes a transceiver configured to transmit and receive signals with the outside and a controller coupled with the transceiver and configured to transmit, to a third node, a first message including first indication information for indicating whether the second node supports handling of a packet data unit (PDU) set of an extended reality (XR) service, and receive, from the third node, a second message, wherein if the first indication information indicates that the second node supports the handling of the PDU set of the XR service, the second message includes XR service configuration information.

In accordance with another aspect of the disclosure, a third node is provided. The third node includes a transceiver configured to transmit and receive signals with the outside and a controller configured to control the transceiver to perform the above method performed by the third node.

In accordance with another aspect of the disclosure, one or more non-transitory computer-readable media storing one or more computer programs including computer-executable instructions that, when executed by one or more processors of a second node in a communication system individually or collectively, cause the second node to perform operations is provided. The operations include transmitting, to a third node, a first message including first indication information for indicating whether the second node supports handling of a packet data unit (PDU) set of an extended reality (XR) service, and receiving, from the third node, a second message, wherein if the first indication information indicates that the second node supports the handling of the PDU set of the XR service, the second message includes XR service configuration information.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a system architecture of System Architecture Evolution (SAE) according to an embodiment of the disclosure;

FIG. 2 is a system architecture according to an embodiment of the disclosure;

FIG. 3 is an architecture of a base station according to an embodiment of the disclosure;

FIG. 4 is a schematic diagram for describing a process in which a user equipment (UE) moves from a first node to a second node according to an embodiment of the disclosure;

FIG. 5 is a schematic diagram for describing another process in which a user equipment (UE) moves from a first node to a second node according to an embodiment of the disclosure;

FIG. 6 is a schematic diagram for describing yet another process in which a user equipment (UE) moves from a first node to a second node according to an embodiment of the disclosure;

FIG. 7 is a schematic diagram for describing a further process in which a user equipment (UE) moves from a first node to a second node according to an embodiment of the disclosure;

FIG. 8 is a schematic diagram for describing an Xn-based process in which a user equipment (UE) moves from a first node to a second node according to an embodiment of the disclosure;

FIG. 9 is a schematic diagram for describing another Xn-based process in which a user equipment (UE) moves from a first node to a second node according to an embodiment of the disclosure;

FIG. 10 is a schematic diagram for describing a next generation (NG)-based process in which a user equipment (UE) moves from a first node to a second node according to an embodiment of the disclosure;

FIG. 11 is a schematic diagram for describing another NG-based process in which a user equipment (UE) moves from a first node to a second node according to an embodiment of the disclosure;

FIG. 12 is a schematic diagram for describing that a first node transmits a message to a second node for controlling data transfer according to an embodiment of the disclosure; and

FIG. 13 is a block diagram of a network node according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Before undertaking the DETAILED DESCRIPTION below, it may be advantageous to set forth definitions of certain words and phrases used throughout this patent document. The term “couple” and its derivatives refer to any direct or indirect communication between two or more elements, whether those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect to or with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The function associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. For example, “at least one of A, B, or C” includes any of the following combinations: A, B, C, A and B, A and C, B and C, and A and B and C.

Additionally, various functions described below can be implemented or supported by one or more computer programs, each of which is formed by computer-readable program code and embodied in a computer-readable medium. The terms “application” and “program” refer to one or more computer programs, software components, instruction sets, procedures, functions, objects, classes, instances, related data or parts thereof appropriate for implementation in suitable computer-readable program code. The phrase “computer readable program code” includes any type of computer code, including source code, objective code and executable code. The phrase “computer readable medium” includes any type of medium that can be accessed by a computer, such as Read-Only Memory (ROM), Random Access Memory (RAM), hard disk drive, compact disc (CD), digital video disc (DVD) or any other type of memory. A “non-transitory” computer-readable medium excludes wired, wireless, optical or other communication links that transfer transitory electrical or other signals. A non-transitory computer-readable medium includes a medium in which data can be stored permanently and a medium in which data can be stored and rewritten later, such as rewritable optical disks or erasable memory devices.

The terms used herein to describe the embodiments of the application is not intended to limit and/or define the scope of the application. For example, unless otherwise defined, the technical or scientific terms used in the disclosure should have ordinary meanings as understood by ordinary skilled in the art to which the application belongs.

It should be understood that “first”, “second” and similar words used in the disclosure do not indicate any order, quantity or importance, but are only used to distinguish different components. Unless clearly indicated otherwise in the context, similar words such as “a”, “an”, “the” and the like in the singular form do not indicate a quantitative limitation, but indicate the existence of at least one.

As used herein, any reference to “one example” or “an example”, “one embodiment” or “an embodiment” means that a particular element, feature, structure or characteristic described in conjunction with the embodiment is included in at least one embodiment. The appearances of the phrases “in one embodiment” or “in one example” in different places in the specification are not necessarily all referring to the same embodiment.

As used herein, “a part of” a certain thing means “at least some of” this thing, so it may mean being less than the entirety thereof or being the entirety thereof. Therefore, “a part of” the thing includes the whole thing as a special case, that is, an example in which the whole thing is a part of the thing.

It will be further understood that words such as “include”, “contain” or the like means that the elements or objects appearing preceding the word encompass the elements or objects listed behind the word as well as their equivalents, without excluding other elements or objects. Words such as “connect”, “interconnect” or the like are not limited to physical or mechanical connections, but may include electrical connection, whether direct or indirect. “Up”, “Down”, “Left” and “Right” are only used to indicate relative positional relationships. When the absolute position of the described object changes, accordingly, the relative positional relationship may change as well.

The various embodiments discussed below for describing the principle of the disclosure in this patent document are for illustration only, and should not be construed as limiting the scope of the disclosure in any way. Those skilled in the art will understand that the principle of the disclosure may be implemented in any suitably arranged wireless communication system. For example, although the following detailed description of the embodiments of the disclosure will focus on LTE and 5G communication systems, those skilled in the art can understand that the main points of the disclosure can also be applied to other communication systems with similar technical backgrounds and channel formats, with slight modifications and basically without departing from the scope of the disclosure. The schemes of the embodiments of the application may be applied to various communication systems. For example, the communication systems may include a Global System for Mobile communications (GSM) system, a Code Division Multiple Access (CDMA) system, a Wideband Code Division Multiple Access (WCDMA) system, General Packet Radio Service (GPRS), Long Term Evolution (LTE) system, LTE Frequency Division Duplex (FDD) system, LTE Time Division Duplex (TDD), Universal Mobile Telecommunication System (UMTS), worldwide interoperability for microwave access (WiMAX) communication system, fifth generation (5th generation, 5G) system or New Radio (NR), etc. In addition, the schemes of the embodiments of the application may be applied to future-oriented communication technologies. In addition, the schemes of the embodiments of the application may be applied to future-oriented communication technologies.

The term “include” or “may include” refers to the existence of a corresponding disclosed function, operation or component which can be used in various embodiments of the disclosure, and does not limit the existence of one or more additional functions, operations, or components. The terms “include” and/or “have” may be construed to represent certain characteristics, numbers, steps, operations, constituent elements, components or combinations thereof, but may not be construed to exclude the possibility of existence of one or more other characteristics, numbers, steps, operations, constituent elements, components or combinations thereof.

The term “or” used in various embodiments of the disclosure includes any of the listed terms or all combinations thereof. For example, “A or B” may include A, may include B, or may include both A and B.

Unless defined differently, all terms used in the disclosure, including technical or scientific terms, have the same meanings as those understood by the skilled in the art as described in the disclosure. Common terms as defined in a dictionary are to be interpreted to have meanings consistent with the context in the relevant technical field o, and are not to be interpreted ideally or excessively, unless clearly defined as such in the disclosure.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

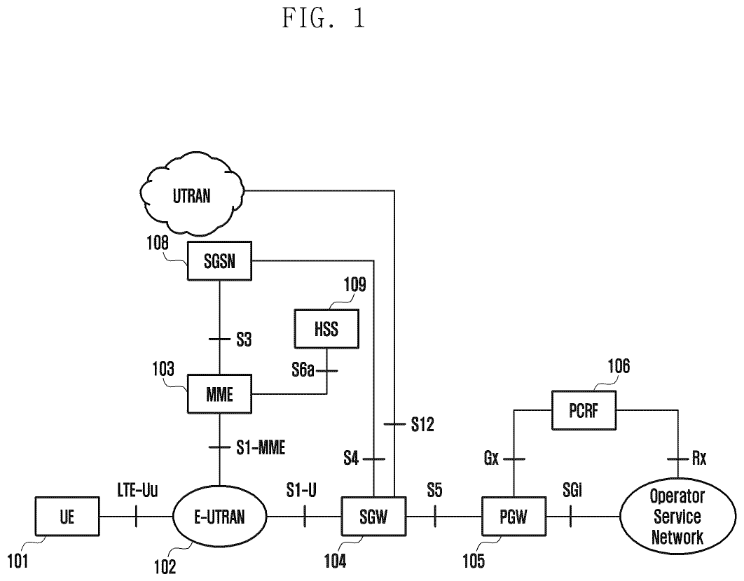

FIGS. 1 to 13 discussed below and various embodiments for describing the principle of the disclosure in this patent document are only for illustration, and should not be interpreted as limiting the scope of the disclosure in any way. Those skilled in the art will understand that the principle of the disclosure may be implemented in any suitably arranged system or device.

FIG. 1 is a system architecture 100 of system architecture evolution (SAE) according to an embodiment of the disclosure.

A user equipment (UE) 101 is a terminal device for receiving data. An evolved universal terrestrial radio access network (E-UTRAN) 102 is a radio access network, which includes a macro base station (eNodeB/NodeB) that provides UE with interfaces to access the radio network. A mobility management entity (MME) 103, for example, is responsible for managing mobility context, session context and security information for the UE. A service gateway (SGW) 104 mainly provides functions for user plane, and the MME 103 and the SGW 104 may be in a same physical entity. A packet data network gateway (PGW) 105 is responsible for functions such as charging, lawful interception, etc., and may be in a same physical entity with the SGW 104 as well. A policy and charging rule function entity (PCRF) 106 provides quality of service (QoS) policies and charging criteria. A general packet radio service support node (SGSN) 108 is a network node device that provides routing for data transmission in a universal mobile telecommunications system (UMTS). A home subscriber server (HSS) 109 is a home subsystem for the UE, and is responsible for protecting user information including a current position of the user equipment, an address of a service node, user security information, and packet data context of the user equipment, etc.

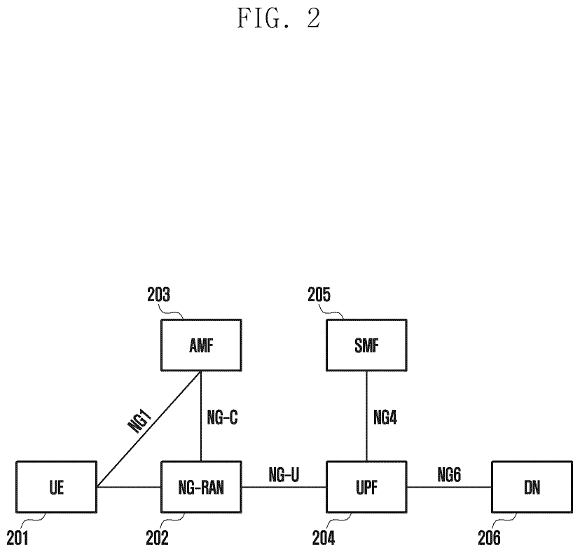

FIG. 2 is a system architecture 200 according to an embodiment of the disclosure. Other embodiments of the system architecture 200 can be used without departing from the scope of the disclosure.

A user equipment (UE) 201 is a terminal device for receiving data. A next generation radio access network (NG-RAN) 202 is a radio access network, which includes a base station (a gNB or an eNB connected to the 5G core network (5GC), and the eNB connected to the 5GC is also referred to as ng-gNB) that provides UE with interfaces to access the radio network. An access control and mobility management function entity (AMF) 203 is responsible for managing mobility context and security information for the UE. A user plane function entity (UPF) 204 mainly provides functions for user plane. A session management function entity (SMF) 205 is responsible for session management. A data network (DN) 206 includes, for example, services of the operators, access to the Internet and services of the third party.

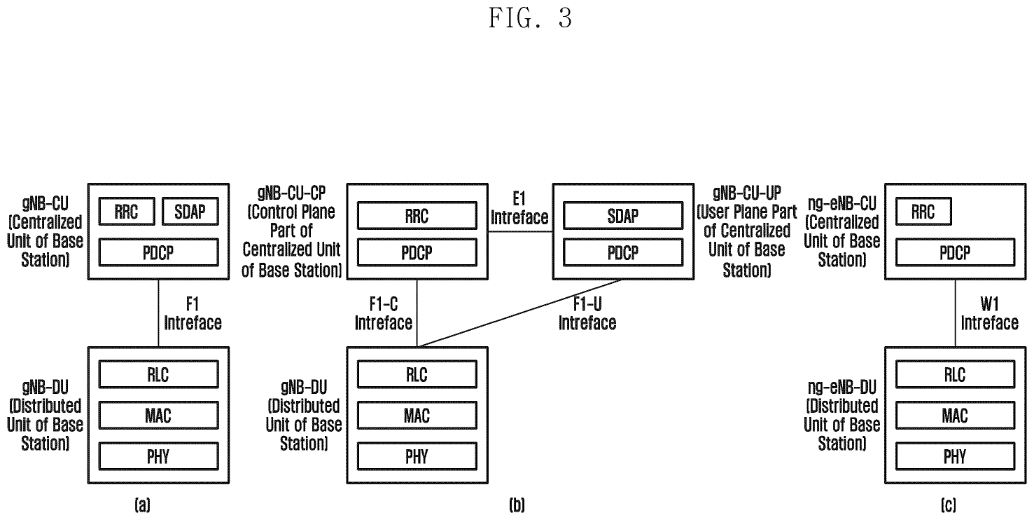

FIG. 3 is an architecture of a base station according to an embodiment of the disclosure. Other embodiments of the base station can be used without departing from the scope of the disclosure.

In an NR system, in order to support network function virtualization and more efficient resource management and scheduling, a base station (gNB/ng-eNB) that provides a wireless network interface for a terminal (UE) may be further divided into a centralized unit gNB-CU/ng-eNB-CU (a gNB central unit/a ng-eNB central unit) and a distributed unit gNB-DU/ng-eNB-DU (a gNB distributed unit/a ng-eNB distributed unit) (abbreviated as CU and DU in the disclosure), as shown in part (a) of FIG. 3. The gNB-CU has radio resource control (RRC), service data adaptation protocol (SDAP) and packet data convergence protocol (PDCP) layers, and the ng-eNB-CU has RRC and PDCP layers. The gNB-DU/ng-eNB-DU has radio link control protocol (RLC), medium access control (MAC) and physical layers. There is a standardized public interface F1 between the gNB-CU and the gNB-DU, and there is a standardized public interface W1 between the ng-eNB-CU and the ng-eNB-DU. The F1 interface is divided into a control plane F1-C and a user plane F1-U. The transport network layer of F1-C is based on Internet Protocol (IP) transfer. In order to transfer signaling more reliably, a stream control transmission protocol (SCTP) protocol is added over IP. The protocol of the application layer is FlAP, see 3GPP TS38.473. The SCTP can provide reliable application layer message transfer. The transport layer of F1-U is User Datagram Protocol (UDP)/IP, and the GPRS Tunneling Protocol for the User Plane (GTP-U) is used to carry user plane protocol data unit (PDU) over UDP/IP. Further, for gNB-CU, as shown in part (b) of FIG. 3, the gNB-CU may include a gNB-CU-CP (a control plane part of the centralized unit of the base station) which contains the functions of the control plane of the base station and has RRC and SDAP protocol layers, and a gNB-CU-UP (a user plane part of the centralized unit of the base station) which contains the functions of the user plane of the base station and has SDAP and PDCP protocol layers. There is a standardized public interface E1 between the gNB-CU-CP and the gNB-CU-UP, and the protocol is E1AP, see 3GPP TS38.463. The interface between the control plane part of the centralized unit of the base station and the distributed unit of the base station is F1-C interface, that is, the control plane interface of F1, and the interface between the user plane part of the centralized unit of the base station and the distributed unit of the base station is F1-U interface, that is, the user plane interface of F1. In the NR system, a base station providing the user plane and the control plane of E-UTRA that accesses the 5G core network is referred to as ng-eNB. In order to support virtualization, such a base station (ng-eNB) can also be further divided into a centralized unit ng-eNB-CU (gNB central unit/ng-eNB central unit) and a distributed unit ng-eNB-DU (gNB distributed unit/ng-eNB distributed unit) (abbreviated as CU and DU in the disclosure), as shown in part (c) of FIG. 3. The ng-eNB-CU has RRC and PDCP layers. The gNB-DU/ng-eNB-DU has radio link control protocol (RLC), medium access control (MAC) and physical layers. There is a standardized public interface W1 between the ng-eNB-CU and the ng-eNB-DU. The W1 interface is divided into a control plane W1-C and a user plane W1-U. The transport network layer of W1-C is based on IP transfer. In order to transfer signaling more reliably, an SCTP protocol is added over IP. The protocol of the application layer is W1AP, see 3GPP TS37.473. The transport layer of W1-U is UDP/IP, and the GTP-U is used to carry user plane protocol data unit (PDU) over UDP/IP.

Compared with 4G, 5G communication technology has a faster transmission speed, so it can provide users with more kinds of communication services. Extended Reality (XR) service is regarded as the key application service to promote the development of 5G technology, and is the general name of three types of services: augmented reality (AR), virtual reality (VR) and mixed reality (MR). The XR service presents high requirements for transmission speed and latency, so it needs more network resources to support normal operation of service. At the same time, in order for portability of an XR device, the size of the battery has been greatly limited, and how to reduce energy consumption has become a big challenge. In order to improve usage experience of XR users, it needs to conduct more in-depth research in terms of reducing power consumption, improving network capacity, and improving XR perception.

In order to conduct better research on the field of XR, a concept of packet data unit set (PDU set) is proposed. A PDU set is composed of one or more PDUs, and one PDU set may be one frame or one video slice in the XR service. One PDU set can only be mapped to one Quality of Service (QoS) flow, and related parameters, such as PDU Set Delay Budget (PSDB), PDU Set Error Rate (PSER) and PDU Set Integrated Handling Indication (PSIHI), of all the PDU sets on one QoS flow are the same.

In an embodiment, the QoS parameters of the PDU set are transmitted by the session management function entity (SMF) of the core network to the access network NG-RAN through the access and mobility management function entity (AMF). When the NG-RAN receives the QoS parameters of at least one PDU set, the NG-RAN needs to start the QoS handling of the PDU set. If the NG-RAN cannot configure the QoS parameters of the PDU set, it will process according to the data of ordinary QoS flow. If the UE moves between an NG-RAN supporting PDU set and an NG-RAN not supporting PDU set, then how to dynamically start the QoS parameter configuration and user plane information transfer for data set, improve the transmission performance of XR service data and satisfy the requirements for XR service is a problem to be solved.

Additionally, when the UE moves, how to reduce the transmission of XR data, save the resources for air interface and improve the transmission efficiency for XR data is another problem to be solved.

The disclosure provides a method performed by a second node in a communication system, comprising: transmitting, to a third node, a first message including first indication information for indicating whether the second node supports handling of a packet data unit (PDU) set of an extended reality (XR) service; and receiving, from the third node, a second message, wherein if the first indication information indicates that the second node supports the handling of the PDU set of the XR service, the second message includes XR service configuration information.

The disclosure further provides a method performed by a third node in a communication system, comprising: receiving, from a second node, a first message including first indication information for indicating whether the second node supports handling of a packet data unit (PDU) set of extended reality (XR) service; and transmitting, to the second node, a second message, wherein if the first indication information indicates that the second node supports the handling of the PDU set of the XR service, the second message includes XR service configuration information.

The disclosure provides a method performed by a first node in a communication system, comprising: transmitting, to a second node, a third message including or not including extended reality (XR) service configuration information corresponding to the first node; receiving, from the second node, a fourth message including second indication information for indicating whether the second node supports handling of a packet data unit (PDU) set of the extended reality (XR) service.

Through the above method, the UE can move between an NG-RAN supporting PDU set and an NG-RAN not supporting PDU set, and can dynamically start the QoS parameter configuration for data set, improve the transmission performance for XR service data and meet the requirements for XR service.

The disclosure provides a method performed by a second node in a communication system, comprising: receiving, from a first node, an eighth message including a sequence number of packet data unit (PDU) set (PSSN); performing corresponding operations based on the eighth message.

Through the above embodiments, when the UE moves, the transmission of XR data can be reduced, the resources for air interface can be saved, and the transmission efficiency for XR data can be improved.

It can be understood that the above technical problems and technical schemes are only shown as examples, and the disclosure is not limited to this. Any technical problems that can be solved by the disclosure and any variations based on the disclosure belong to the protection scope of the disclosure.

The embodiments of the disclosure are further described below with reference to the accompanying drawings.

The text and drawings are provided as examples only to help understand the disclosure. They should not be construed as limiting the scope of the disclosure in any way. Although certain embodiments and examples have been provided, based on the disclosure herein, it is obvious to those skilled in the art that changes can be made to the illustrated embodiments and examples without departing from the scope of the disclosure.

The NR and LTE in the following description are merely examples of different radio access technologies (RATs), and can also be other RATs. The NG-RAN, gNB, AMF, SMF are merely examples of different nodes, and can also be other nodes. The disclosure is not limited to this.

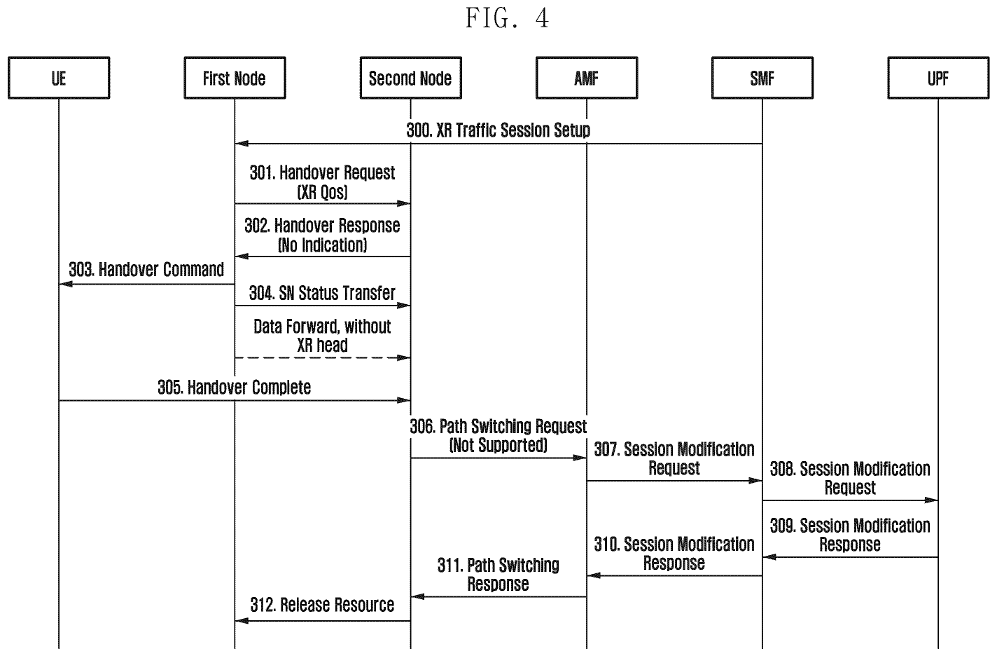

FIG. 4 is a schematic diagram for describing a process in which a user equipment (UE) moves from a first node to a second node according to an embodiment of the disclosure. Herein, a first node (i.e. a source base station serving a UE) supports XR service, and when the UE is located in the source base station, the UE is receiving the XR service. In this example, the UE moves to a second node (i.e. a destination base station), in which the destination base station may or may not support XR service.

The specific process of the embodiment of the disclosure is shown in FIG. 4. Referring to FIG. 4, the method of this embodiment may include one or more steps from step S300 to step S312.

Step 300: An SMF configures a base station a XR-related session.

The SMF transmits a message to the base station (i.e. the first node) to configure XR service through an AMF. The message transmitted by the AMF may be a PDU session setup request or a UE context setup request or the like, and the message carries an SM container transmitted by the SMF. The SM container, for example, carries configuration information for XR service, which may include a PDU session identification, an identification of QoS flow, service quality requirements for QoS flow, periodicity of XR data, time of arrival of a data burst, duration of data survival, configuration for jitter, etc. The message may further include QoS parameter configuration for packet data unit sets of XR service (QoS parameters of PDU set). This step is necessary for the following embodiments and is similar, so it is omitted in the description of the following embodiments.

In an embodiment, the QoS parameter configuration of (one or more) PDU sets is transferred from the core network to the access network, and the related parameters of PDU sets include at least one piece of the following information:

PSIHI: indicates whether usage of a PDU set by the application layer needs all PDUs of the PDU set. Only when all PDUs are received can the application layer correctly resume the information carried by the PDUs, which means that if a certain PDU in one PDU set is lost, the remaining PDUs in the whole PDU set, even if being received, are useless and need to be discarded.

PSDB: defines an upper limit of a delay that a PDU set may experience at the UPF for transmission between the UE and the N6 termination point, that is, a duration between the reception time of the first PDU (which will be at the N6 termination point for DL or at the N6 termination point of UE for UL) and the time when all PDUs of the PDU set have been successfully received (which will be at the UE for DL or at the N6 termination point for UL). The PSDB is applied to a DL PDU set received by a PDU Session Anchor User Plane Function (PSA-UPF) on the N6 interface, and applied to a UL PDU set transmitted by the UE.

PDER: defines a PDU set that has been processed by a transmitter of a link layer protocol (e.g., RLC in a RAN accessed by 3GPP) but have not been successfully delivered to an upper layer by a corresponding receiver. Therefore, the PSER defines an upper limit of a loss rate of non-congestion related PDU sets. The purpose of the PSER is to allow appropriate link layer protocol configuration (e.g., RLC and HARQ in the RAN accessed by 3GPP).

The session of XR service is set up, and the UPF transmits PDUs of XR service to the access network. A GPRS Tunneling Protocol (GTP) is employed between the UPF and the access network. The UPF transmits GTP-U data packets to the access network, in which a GTP user data packet carries packet header information and data information. In the packet header part, information related to XR is also added. The information related to XR may at least include one piece of the following information:

Sequence number of PDU set (PSSN): the PDUs belonging to one same PDU set all have the same PDU set sequence number (SN). The PDU set SN is incremented, indicating the PDU set to which the PDUs belongs.

Sequence number of PDU (PDU SN): one PDU set may contain a plurality of PDUs, and the PDU SN indicates a sequence number of the PDUs in a certain PDU set.

In an embodiment, indication information for indicating the last PDU in a PDU set: indicates with one bit whether the PDU is the last PDU in this PDU set.

Size of a PDU set: indicates how many bytes in a PDU set.

Importance indication information of a PDU set: different PDU sets may have different degrees of importance, which may be expressed by PDU set importance (PSI), whose value may be, for example, high/medium/low or 0-7. Different PDU sets mapped to one same QoS flow can also have different PSIs. A PSI may be told to the RAN by the UPF through a GTP-U header. When a network congestion occurs at the RAN side, a corresponding PDU set may be discarded according to the value of PSI (e.g., some PDU sets with smaller PSI values are discarded), so as to mitigate or solve the network congestion.

Step 301: A first node transmits a handover request message to a second node.

The source base station decides to hand over the UE to the destination base station according to a measurement result of the UE. The handover request message contains one or more of: an identification of a destination cell, and a list of ongoing PDU sessions by the UE, which contains PDU session identifications (IDs), a QoS flow ID, service quality requirements for QoS flow, and uplink data receiving address, such as a transport layer IP address and tunnel identification (TEID), which is allocated by a user plane node UPF in the core network. The message further contains information about data forwarding of the source base station, and the information about data forwarding contains a suggestion that data forwarding is needed for the uplink data and/or downlink data of a certain session or a certain data radio bearer (DRB).

For XR service, the handover request message further contains periodicity of XR data transferred on a QoS flow, time of arrival of a data burst, duration of data survival, configuration for jitter, etc. The handover request further contains QoS parameter configuration for packet data unit set of XR service, that is, contains at least one piece of the following information: QoS flow ID, a type of PDU set, an identification of PDU set, PSDB, PDER, PSIHI.

Step 302: The second node transmits a handover response message to the first node.

The destination base station sets up resources corresponding to a session according to session-related information contained in the handover request message. The session-related information, for example, contains a session identification, and the session contains information of QoS flow, as well as a suggestion for data forwarding. According to the suggestion for forwarding, the destination base station decides whether data forwarding is needed for the session and/or for the DRB, and if so, the destination base station allocates a data forwarding address for the session or DRB.

The destination base station transmits a handover response message to the source base station. The message carries an identification of the UE over Xn interface, bearer information or PDU session information accepted at the destination base station, data forwarding information, and a handover command message to be transmitted to the UE. The data forwarding information contains an identification of a QoS flow for which data forwarding is to be carried out, an uplink and/or downlink transport layer IP address and GTP tunnel identification corresponding to the PDU session, as well as an identification of a DRB for which data forwarding is to be carried out, and an uplink and/or a downlink transport layer IP address and GTP tunnel identification corresponding to the DRB.

In an embodiment, for the ongoing XR service by the UE, if the destination base station supports XR service, the destination base station saves and uses relevant configuration parameters of XR service, including configuration for jitter of XR service, QoS parameter configuration for PDU set of XR service, etc., and schedules data according to the relevant configuration parameters of XR service. In the handover response message, the destination base station may contain the indication information of XR QoS parameter acceptance, or the indication information that the destination base station supports XR service, through which the source base station gets to know that the destination base station supports XR service. If the destination base station decides the data forwarding of XR service and contains the data forwarding information in the handover response message, the source base station transmits, according to the data forwarding information, the data to be forwarded to the data forwarding address indicated by the destination base station. When the source base station forwards data to the destination base station, the XR-related information may be contained in a GTP header.

In another embodiment, for the ongoing XR service by the UE, if the destination base station does not support XR service, the destination base station may not be able to parse and understand the relevant configuration parameters of XR service, including configuration for jitter of XR service and QoS parameter configuration for PDU set of XR service. At this time, the destination base station will consider the XR service as an ordinary service and set up a data radio bearer (DRB) of QoS according to the QoS parameters corresponding to the original QoS flow, that is, process the QoS flow of XR service by considering it as an ordinary QoS flow. In the handover response message, the destination base station does not contain any information related to XR. By not containing any indication information related to XR, the source base station can get to know that the destination base station does not support XR service, that is, the destination base station processes the XR service by considering it as an ordinary session or an ordinary QoS flow. If the destination base station decides the data forwarding of the session related to XR and contains the data forwarding information in the handover response message, the source base station transmits, according to the data forwarding information, the data to be forwarded to the data forwarding address indicated by the destination base station. When the source base station forwards data to the destination base station, the XR-related information may not be contained the GTP header. In this way, it can reduce the unnecessary information contained in the data packet header, reduce the redundancy of the packet header, save the time for data forwarding and the required transport layer resources, and improve the overall system performance.

In still another embodiment, in case of conditional handover, a configuration for conditional handover transmitted by the destination base station to the UE may also carry the indication information of whether the destination base station supports XR service. In the conditional handover, the source base station prepares a plurality of destination base stations, each of which contains the indication information of whether the base station supports XR in the RRC message transmitted to the UE. After the UE receives the configuration for conditional handover, the UE may refer to the information of whether the candidate base station supports XR and decide which of the candidate base stations to select as the destination base station.

Step 303: The source base station transmits a handover command to the UE.

The source base station transmits the handover command transmitted by the destination base station to the UE.

Step 304: The source base station transmits an SN status transfer message to the destination base station.

In a normal handover process, the source base station may suspend the transmission and reception of data, stop allocating Packet Data Convergence Protocol (PDCP) sequence numbers to downlink service data units (SDUs), and stop transmitting uplink SDUs to the core network.

The message in step 304 carries an identification of a DRB, an uplink COUNT value and a downlink COUNT value of the DRB. The COUNT value contains a PDCP SN and a hyperframe number (HFN number). After receiving this value, the destination base station allocates the PDCP sequence number contained in the DL COUNT value to the first downlink data packet that has not been allocated the PDCP sequence number. If the source base station, for example, accepts the uplink data forwarding required by the destination base station, the message may further contain a reception status of a lost or received uplink SDU.

For the ongoing XR service by the UE, the handling that the source base station makes is the same as the ordinary service, except one difference that the source base station may or may not contain the XR-related information in the GTP header when forwarding data of XR, according to whether the destination base station supports XR service. In this way, it can reduce the unnecessary information contained in the data packet header, reduce the redundancy of the packet header, save the time for data forwarding and the required transport layer resources, and improve the overall system performance.

Step 305: The UE synchronizes with a destination cell and transmits a handover complete message to the destination base station.

As described above, when selecting a destination cell, the UE may refer to whether the destination cell/destination base station supports XR service. When the UE has an ongoing XR service, it may select a base station that supports XR service as the destination base station on the premise of satisfying the conditional handover.

Step 306: The destination base station transmits a path switching request message to the core network AMF.

In an embodiment, the path switching request message contains location information of the UE and a list of PDU sessions for switching to the destination base station. The location information of the UE contains a unique identification of the cell where the UE is located and an identification of the tracking area where the UE is located. The specific information of the PDU sessions for switching to the destination base station is contained in an N2 SM container, which contains an address of user plane and information of QoS flow.

If the destination base station supports XR service, the message further contains the indication information that the destination base station supports XR service, which contains the indication information of XR QoS parameter acceptance, or is by means of an explicit indication information. The indication information of XR QoS parameter acceptance may indicate that the QoS corresponding to the PDU set of a certain XR service is accepted. The explicit indication information indicates that the base station supports XR service by containing one indication, whereas not containing this indication information means that the base station does not support it, or indicates whether the base station supports XR service through one indication.

If the destination base station does not support XR service, the message contains no indication information related to XR, or contains indication information that the base station does not support XR service.

The above indication information in this step can be transmitted from the base station to the SMF through the N2 SM container, or be contained outside the SM container and transmitted to the AMF, which then transmits it to the SMF through step 307.

Step 307: The AMF transmits a session modification request message to the SMF.

The AMF transmits, to the SMF, a message carrying the above N2 SM container, and the information in the container is parsed and saved by the SMF. The message may further contain location information of the UE. Alternatively, the message may further contain indication information that the destination base station supports XR.

Step 308: The SMF transmits the session modification request message to the UPF.

The SMF transmits, to the UPF, the session modification request message containing the downlink data receiving address allocated by the destination base station, the indication information that the destination base station supports XR, or the indication information indicating whether the UPF contains XR-related information in the GTP header.

If the destination base station does not support XR, the UPF may not contain XR-related information in the GTP header when transmitting data packets to the destination base station. The XR-related information contains one or more of sequence number of PDU set, sequence number of PDU, indication information indicating the last PDU of the PDU set, a size of PDU set and importance indication information of PDU set. In this way, it can reduce the unnecessary information contained in the data packet header, reduce the redundancy of the packet header, save the time for data forwarding and the required transport layer resources, and improve the overall system performance.

Step 309: The UPF transmits a session modification response message to the SMF.

The UPF transmits a response message to the SMF. The message may contain the uplink data receiving address allocated by the UPF.

Step 310: The SMF transmits the session modification response message to the AMF.

In an embodiment, the SMF transmits the response message to the AMF. The message may contain an N2 SM container, which contains the uplink data receiving address allocated by the UPF, and the data receiving address contains the transport layer IP address and the GTP tunnel identification. The container further contains the received information of QoS flow, and the alternative QoS parameters of QoS flow.

Step 311: The AMF transmits a path switching response message to the destination base station.

The AMF transmits a response message to the destination base station. The message contains the N2 SM container received in step 310.

The path switching response message, for example, contains an identification of the UE at NG interface, bearer information of successful switching or an identification of PDU Session, and an N2 SM container which contains contents of SMF configuration, is transparent to the AMF, and contains information of user plane allocated by the UPF, and information of QoS.

Step 312: The destination base station transmits a UE context release request message to the source base station.

After the UE is handed over to the destination base station, the destination base station may transmit a UE context release request message to request the source base station to release the saved UE-related information and resources.

So far, the handover process of the above embodiment has been completed.

Through the above embodiment, the UE can move between an NG-RAN supporting PDU set and an NG-RAN not supporting PDU set, and can dynamically start the QoS parameter configuration for data set, improve the transmission performance for XR service data and meet the requirements for XR service.

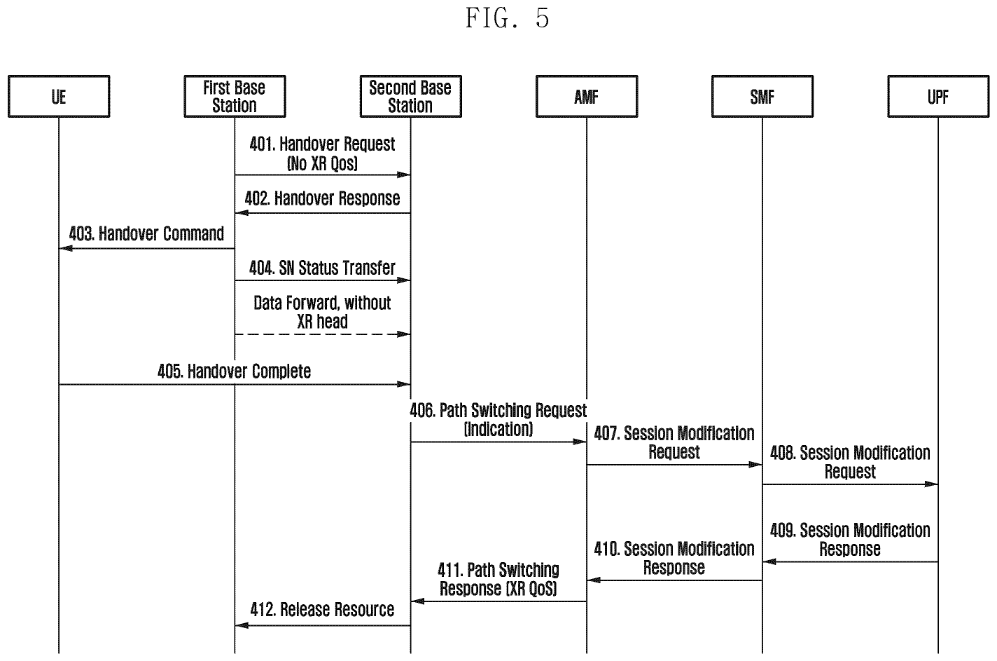

FIG. 5 is a schematic diagram for describing another process in which a user equipment (UE) moves from a first node to a second node according to an embodiment of the disclosure. Herein, the first node (i.e., the source base station serving the UE) does not support XR service, that is, the XR service is transferred as an ordinary service at the source base station. In this embodiment, the UE moves to the second node, that is, the destination base station, which can support XR service. At this time, setting up XR service as soon as possible can improve the user experience of XR service.

The specific process of the embodiment of the disclosure is shown in FIG. 5. Referring to FIG. 5, the method of this embodiment may include one or more steps from step S401 to step S412.

Step 401: The first node transmits a handover request message to the second node.

The source base station decides to hand over the UE to the destination base station according to a measurement result of the UE. The handover request message contains one or more of: an identification of a destination cell, and a list of ongoing PDU sessions by the UE, which contains PDU session identifications (IDs), a QoS flow ID, service quality requirements for QoS flow, and uplink data receiving address, such as a transport layer IP address and tunnel identification (TEID), which is allocated by a user plane node UPF in the core network. The message further contains information about data forwarding of the source base station, and the information about data forwarding contains a suggestion that data forwarding is needed for the uplink data and/or downlink data of a certain session or a certain DRB.

For the XR service, the source base station transmits it as a normal service, and the handover request message does not contain special parameters of XR service, that is, does not contain configuration for jitter of XR service, etc., and does not contain QoS parameter configuration for packet data unit set of XR service.

Step 402: The second node transmits a handover response message to the first node.

The destination base station, for example, sets up resources corresponding to a session according to session-related information contained in the handover request message. The session-related information contains a session identification, and the session contains information of QoS flow, as well as a suggestion for data forwarding. According to the suggestion for forwarding, the destination base station decides whether data forwarding is needed for the session and/or for the DRB, and if so, the destination base station allocates a data forwarding address for the session or DRB.

The destination base station transmits a handover response message to the source base station. In an embodiment, the message carries an identification of the UE over Xn interface, bearer information or PDU session information accepted at the destination base station, data forwarding information, and a handover command message to be transmitted to the UE. The data forwarding information contains an identification of a QoS flow for which data forwarding is to be carried out, an uplink and/or downlink transport layer IP address and GTP tunnel identification corresponding to the PDU session, as well as an identification of a DRB for which data forwarding is to be carried out, and an uplink and/or downlink transport layer IP address and GTP tunnel identification corresponding to the DRB.

Since the handover request does not contain any specific information related to XR, the destination base station does not know whether the UE is carrying out XR service, and the handover response message does not contain the indication information of XR or the specific information related to XR.

In case of conditional handover, a configuration for conditional handover transmitted by the destination base station to the UE may also carry the indication information of whether the destination base station supports XR service. In the conditional handover, the source base station prepares a plurality of destination base stations, each of which contains the indication information of whether the base station supports XR in the RRC message transmitted to the UE. After the UE receives the configuration for conditional handover, the UE may refer to the information of whether the candidate base station supports XR and decide which of the candidate base stations to select as the destination base station.

Step 403: The source base station transmits a handover command to the UE.

In an embodiment, the source base station transmits the handover command transmitted by the destination base station to the UE.

In case of conditional handover, a configuration for conditional handover transmitted by the destination base station to the UE may also carry the indication information of whether the destination base station supports XR service. In the conditional handover, the source base station prepares a plurality of destination base stations, each of which contains the indication information of whether the base station supports XR in the RRC message transmitted to the UE. After the UE receives the configuration for conditional handover, the UE may refer to the information of whether the candidate base station supports XR and decide which of the candidate base stations to select as the destination base station.

Step 404: The source base station transmits an SN status transfer message to the destination base station.

In a normal handover process, the source base station may suspend the transmission and reception of data, stop allocating Packet Data Convergence Protocol (PDCP) sequence numbers to downlink service data units (SDUs), and stop transmitting uplink SDUs to the core network.

The message in step 304 carries an identification of a DRB, an uplink COUNT value and a downlink COUNT value of the DRB. After receiving this value, the destination base station allocates the PDCP sequence number contained in the DL COUNT value to the first downlink data packet that has not been allocated the PDCP sequence number. If the source base station accepts the uplink data forwarding required by the destination base station, the message may further contain a reception status of a lost or received uplink SDU.

Step 405: The UE synchronizes with a destination cell and transmits a handover complete message to the destination base station.

When selecting a destination cell, the UE may refer to whether the destination cell/destination base station supports XR service. When the UE has an ongoing XR service, it may select a base station that supports XR service as the destination base station on the premise of satisfying the conditional handover.

Step 406: The destination base station transmits a path switching request message to the core network AMF.

The path switching request message, for example, contains location information of the UE and a list of PDU sessions for switching to the destination base station. The location information of the UE contains a unique identification of the cell where the UE is located and an identification of the tracking area where the UE is located. The specific information of the PDU sessions for switching to the destination base station is contained in an N2 SM container, which contains an address of the user plane and information of QoS flow.

If the destination base station supports XR service, the message further contains indication information that the destination base station supports XR service, indicating that the base station supports XR service, or indicating whether the base station supports XR service through one indication.

The above indication information in this step can be transmitted from the base station to the SMF through the N2 SM container, or be contained outside the SM container and transmitted to the AMF, which then transmits it to the SMF through step 407.

Step 407: The AMF transmits a session modification request message to the SMF.

The AMF transmits, to the SMF, a message carrying the above N2 SM container, and the information in the container is parsed and saved by the SMF. The message may further contain location information of the UE. Alternatively, the message may further contain indication information that the destination base station supports XR.

Step 408: The SMF transmits the session modification request message to the UPF.

The SMF transmits, to the UPF, the session modification request message containing the downlink data receiving address allocated by the destination base station, the indication information that the destination base station supports XR, or the indication information indicating whether the UPF contains XR-related information in the GTP header.

If the destination base station supports XR, the UPF knows that the source base station does not support XR service. When the UPF transmits a data packet to the source base station, the GTP header does not contain XR-related information. When the UPF knows that the destination base station supports XR service, then when the UPF transmits a data packet to the destination base station, it may contain the XR-related information in the GTP header. The base station can perform scheduling and handling of PDU set on the data of XR service, which improves the quality of XR service and improves the user satisfaction with XR service.

Step 409: The UPF transmits a session modification response message to the SMF.

The UPF transmits a response message to the SMF. The message may contain the uplink data receiving address allocated by the UPF.

Step 410: The SMF transmits the session modification response message to the AMF.

The SMF transmits the response message to the AMF. The message may contain an N2 SM container, which contains the uplink data receiving address allocated by the UPF, and the data receiving address contains the transport layer IP address and the GTP tunnel identification. The container further contains the received information of QoS flow, and the alternative QoS parameters of QoS flow.

When the SMF knows that the destination base station supports XR service, but the source base station does not support XR service, the SMF may contain, in the N2 SM container, the relevant configuration information for XR service, which contains QoS flow identification of XR service, periodicity of XR data transmitted on a QoS flow, time of arrival of a data burst, duration of data survival, configuration for jitter, etc. The relevant configuration information contains QoS parameter configuration for packet data unit set of XR service, that is, it contains at least one piece of the following information: QoS flow ID, a type of PDU set, an identification of PDU set, PSDB, PDER, PSIHI. In this way, the destination base station can get the specific configuration information for XR as soon as possible, and can schedule and handle the data according to the features of XR as soon as possible, which improves the performance of XR service and improves the customer satisfaction of XR service.

The relevant configuration information for XR service can also be modified through a separate session modification process. In the later separate process, the configuration for jitter of XR service and the QoS parameter configuration for packet data unit set of XR service is notified to the destination base station.

Step 411: The AMF transmits a path switching response message to the destination base station.

The AMF transmits, for example, a response message to the destination base station. The message contains the N2 SM container received in step 310.

The path switching response message contains an identification of the UE at NG interface, bearer information of successful switching or an identification of PDU Session, and an N2 SM container which contains contents of SMF configuration, is transparent to the AMF, and contains information of a user plane allocated by the UPF, and information of QoS.

Step 412: The destination base station transmits a UE context release request message to the source base station.

After the UE is handed over to the destination base station, the destination base station may transmit a UE context release request message to request the source base station to release the saved UE-related information and resources.

So far, the handover process of the above embodiment has been completed.

Through the above embodiment, the UE can move between an NG-RAN not supporting PDU set and an NG-RAN supporting PDU set, and can dynamically start the QoS parameter configuration for data set, and provide the QoS parameter configuration to the NG-RANs as soon as possible, which improves the transmission performance of XR service data and satisfies the requirements for XR service.

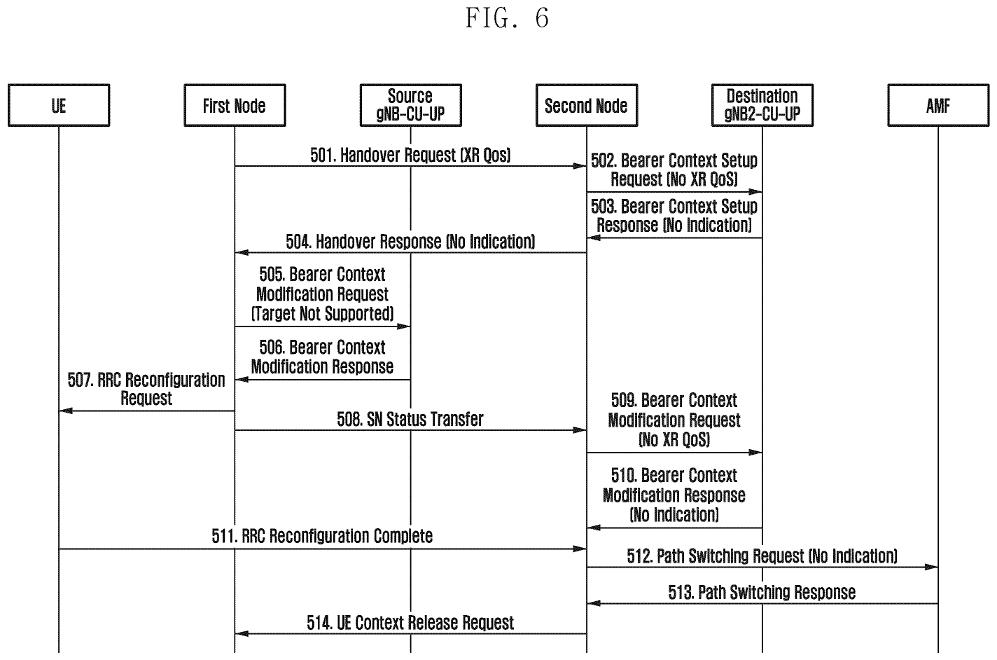

FIG. 6 is a schematic diagram for describing another process in which a user equipment (UE) moves from a first node to a second node according to an embodiment of the disclosure. Herein, the first node (i.e. the source base station serving the UE) supports XR service, and when the UE is located in the source base station, the UE is receiving XR service. In this example, the UE moves to the second node (i.e. the destination base station), in which the destination base station may or may not support XR service. The first node and the second node are split base station structures.

The specific process of the embodiment of the disclosure is shown in FIG. 6. Referring to FIG. 6, the method of this embodiment may include one or more steps from step S501 to step S514.

Step 501: The first node transmits a handover request message to the second node.

The first node is the centralized control entity of the source base station (e.g., the source gNB-CU-CP), and decides to hand over, according to a measurement result of the UE, the UE to the second node, which is the centralized control entity of the destination base station (e.g., the destination gNB-CU-CP). The handover request message contains one or more of: an identification of a destination cell, and a list of ongoing PDU sessions by the UE, which contains PDU session identifications (IDs), a QoS flow ID, service quality requirements for QoS flow, and an uplink data receiving address, such as a transport layer IP address and tunnel identification (TEID), which is allocated by a user plane node UPF in the core network. The message further contains the information about data forwarding of the first node, and the information about data forwarding includes a suggestion that data forwarding is needed for the uplink data and/or downlink data of a certain session or a certain DRB.

For XR service, the handover request message further contains periodicity of XR data transferred on a QoS flow, time of arrival of a data burst, duration of data survival, configuration for jitter, etc. The handover request contains QoS parameter configuration for packet data unit set of XR service, that is, contains at least one piece of the following information: QoS flow ID, a type of PDU set, an identification of PDU set, PSDB, PDER, PSIHI.

Step 502: The second node transmits a bearer context setup request message to the destination user plane entity.

The user plane entity may be the destination gNB-CU-UP, which will be described below with the second node being the destination gNB-CU-CP and the user plane entity being the destination gNB-CU-UP as an example. The destination gNB-CU-CP transmits, to the destination gNB-CU-UP, a bearer context setup request message, which contains an identification of the UE at E1 interface, encryption information, an identification of service operator (public land mobile network (PLMN) ID), an identification of the UE in the access network (RAN ID), an identification of the distributed unit (DU) of the base station, and a list of PDU sessions to be set up. The list of PDU sessions contains PDU session identification, single-network slice selection assistance information (S-NSSAI), encryption indication, and an uplink transport layer address, such as IP address and TEID, which is allocated by the user plane node UPF of the core network for receiving uplink data. The list of PDU sessions further contains a list of DRBs to be set up, which contains a DRB identification, quality of service (QoS) of DRB, SDAP configuration, PDCP configuration, PDCP sequence number status information, Cell group information, and a list of QoS flows to be set up. The gNB-CU-CP decides the mapping of QoS flow to data wireless channel. The list of QoS flows contains identifications of QoS flows, QoS of QoS flow and so on.

For the ongoing XR service by the UE, if the destination gNB-CU-CP supports PDU set handling, the destination gNB-CU-CP saves and uses relevant configuration parameters for PDU set of XR service, and the message in step 502 contains the relevant configuration parameters for PDU set of XR service.

For the ongoing XR service by the UE, if the destination gNB-CU-CP does not support PDU set handling, the destination gNB-CU-CP may not be able to parse and understand the relevant configuration parameters for PDU set. At this time, the destination gNB-CU-CP will consider the XR service as an ordinary service and set up a data radio bearer (DRB) of QoS according to the QoS parameters corresponding to the original QoS flow, and the bearer context setup request message does not contain any information related to PDU set.

Step 503: The destination gNB-CU-UP transmits a bearer setup response message to the second node (i.e., the destination gNB-CU-CP).

The destination gNB-CU-UP, for example, transmits a bearer context setup response message to the destination gNB-CU-CP. The message contains an identification of the UE at E1 interface, and a list of successfully setup PDU sessions, which contains identifications of PDU sessions, encryption results, and a downlink transport layer address which is allocated by the gNB-CU-UP for receiving downlink data transmitted by the core network. The message further contains a list of successfully setup DRBs, which contains DRB identifications, information of DRB data forwarding, uplink user plane information of DRB which contains a user plane transport layer addresses, cell group identifications, etc. The uplink user plane address is allocated by the destination gNB-CU-CP for receiving uplink data transmitted by the DU.

For the ongoing XR service by the UE, if the destination gNB-CU-UP supports PDU set handling, the message in step 503 contains indication information that the gNB-CU-UP supports PDU set handling, which may be implicitly indicated by containing indication information of XR QoS parameter acceptance in the message, or indicate, through an explicit indication information, that the destination gNB-CU-UP supports PDU set and/or does not support PDU set. In an embodiment, the indication information of XR QoS parameter acceptance may indicate that the QoS corresponding to the PDU set of a certain XR service is accepted.

For the ongoing XR service by the UE, if the destination gNB-CU-UP does not support PDU set, the message does not contain the indication information of XR PDU set, or contains the indication information that the destination gNB-CU-UP does not support PDU set.

The destination gNB-CU-UP can get to know whether a conditional handover has been performed from a CHO indication contained in the bearer context setup request message. In case of conditional handover, the destination gNB-CU-UP response message may also carry the indication information of whether the destination gNB-CU-UP supports PDU set. The second node, for example, transmits it to the UE through the first node. In the conditional handover, the first node prepares a plurality of destination base stations, each of which contains the indication information of whether the base station supports PDU Set in the RRC message transmitted to the UE. After the UE receives the configuration for conditional handover, the UE can refer to the information of whether the candidate base station supports PDU set and decide which of the candidate base stations to select as the destination base station.

The process from the gNB-CU-CP to the gNB-DU is omitted here. Similarly, the gNB-DU may implicitly indicate that the gNB-DU supports PDU set by containing the indication information of XR QoS parameter acceptance in the UE context setup response message, or indicate, through an explicit indication information, that the gNB-DU supports PDU set and/or does not support PDU set. The indication information of XR QoS parameter acceptance may indicate that the QoS corresponding to the PDU set of a certain XR service is accepted.

Step 504: The second node transmits a handover response message to the first node.

The destination gNB-CU-CP sets up resources corresponding to a session according to session-related information contained in the handover request message. The session-related information contains a session identification, and the session contains information of QoS flow, as well as a suggestion for data forwarding. According to the suggestion for forwarding, the destination gNB-CU-CP decides whether data forwarding is needed for the session and/or for the DRB, and if so, the destination gNB-CU-CP allocates a data forwarding address for the session or DRB.

In an embodiment, the destination gNB-CU-CP transmits a handover response message to the source gNB-CU-CP. The message carries an identification of the UE over Xn interface, bearer information or PDU session information received at the destination gNB-CU-CP, data forwarding information, and a handover command message to be transmitted to the UE. The data forwarding information contains an identification of a QoS flow for which data forwarding is to be carried out, an uplink and/or downlink transport layer IP address and GTP tunnel identification corresponding to the PDU session, as well as an identification of a DRB for which data forwarding is to be carried out, and an uplink and/or downlink transport layer IP address and GTP tunnel identification corresponding to the DRB.

For the ongoing XR service by the UE, if the destination base station supports PDU set handling, the destination base station supporting means that the gNB-CU-CP, the gNB-CU-UP and the gNB-DU all support PDU set handling. The destination base station, for example, saves and uses the relevant configuration parameters for PDU set of XR service, including configuration for jitter of XR service, QoS parameter configuration for PDU set of XR service, and schedules data according to the relevant configuration parameters of XR service. In the handover response message, the destination gNB-CU-CP may contain the indication information of XR QoS parameter acceptance, or the indication information that the destination base station supports XR service, indicating that the destination base station supports PDU set and/or does not support PDU set. Through this indication information, the source gNB-CU-CP get to know that the destination base station supports PDU set handling. If the destination gNB-CU-CP decides the data forwarding of XR service and contains the data forwarding information in the handover response message, the source gNB-CU-CP transmits, according to the data forwarding information, the data to be forwarded to the data forwarding address indicated by the destination gNB-CU-CP. When the source gNB-CU-CP forwards the data to the destination gNB-CU-CP, it may contain XR-related information in the GTP header.

For the ongoing XR service by the UE, if the destination base station does not support PDU set handling, the destination base station not supporting means that one of the gNB-CU-CP, the gNB-CU-UP and the gNB-DU does not support PDU set handling. The destination gNB-CU-CP may not be able to parse and understand the relevant configuration parameters for PDU set of XR service, including configuration for jitter of XR service, and QoS parameter configuration for PDU set of XR service. At this time, the destination gNB-CU-CP will consider the XR service as an ordinary service and set up a data radio bearer (DRB) of QoS according to the QoS parameters corresponding to the original QoS flow, that is, process the QoS flow of XR service by considering it as an ordinary QoS flow. In the handover response message, the destination gNB-CU-CP does not contain any information related to XR PDU set. By not containing any indication information related to XR, the source gNB-CU-CP can get to know that the destination base station does not support PDU set handling, that is, the destination base station processes the XR service by considering it as an ordinary session or an ordinary QoS flow. In an embodiment, if the destination gNB-CU-CP decides the data forwarding of the session related to XR and contains the data forwarding information in the handover response message, the source gNB-CU-CP transmits, according to the data forwarding information, the data to be forwarded to the data forwarding address indicated by the destination gNB-CU-CP. When the source gNB-CU-CP forwards the data to the destination gNB-CU-CP, it may not contain the XR-related information in the GTP header. In this way, it can reduce the unnecessary information contained in the data packet header, reduce the redundancy of the packet header, save the time for data forwarding and the required transport layer resources, and improve the overall system performance.

In case of conditional handover, in the configuration for conditional handover transmitted by the destination gNB-CU-CP to the UE, the indication information of whether the destination base station supports PDU set handling can be carried. In the conditional handover, the source base station prepares a plurality of destination base stations, each of which contains the indication information of whether the base station supports PDU set handling in the RRC message transmitted to the UE. After the UE receives the configuration for conditional handover, the UE can refer to the information of whether the candidate base station supports PDU set handling and decide which of the candidate base stations to select as the destination base station.

In step 505, the first node transmits a bearer context modification request message to a source user plane entity (e.g., the source gNB-CU-UP, which is described in the following description by taking the source gNB-CU-UP as an example, but it can be understood that the source user plane entity can also be the source gNB-DU).

The first node (i.e., the source gNB-CU-CP) transmits, to the source gNB-CU-UP, a bearer context modification request message, which contains an identification of the UE at E1 interface, an identification of a session for which data forwarding is to be carried out, and data forwarding information, which contains the transport layer address and tunnel identification for the uplink and/or downlink data forwarding, and an identification of a QoS flow for which data forwarding is to be carried out.

When the source gNB-CU-CP gets to know from the saved UE context that the UE is engaged in XR service, and the received handover response does not contain the indication information that the destination base station supports XR service, as mentioned above, the indication information can be implicitly indicated by containing the indication information of XR QoS parameter acceptance in the message, or be by means of an explicit indication information, then the source gNB-CU-CP can get to know that the destination base station does not support PDU set handling. At this time, the data forwarding of the destination gNB-CU-CP may not contain the XR-related information in the GTP header. The message in which the source gNB-CU-CP transmits the bearer context modification request message to the source user plane entity, may indicate that the destination base station does not support XR, or indicate that the data forwarding does not need to add the XR-related information.

Step 506: The source user plane entity transmits a bearer context modification request message to the first node.

The message, for example, contains an identification of the UE at E1 interface and a list of successfully modified PDU sessions, which contains session identifications, identifications of data radio bearer and PDCP sequence number status information. The PDCP sequence number status information contains a status of the received PDCP SDU, an uplink COUNT value and a downlink COUNT value. A COUNT value contains a PDCP SN and a hyperframe number (HFN number).

Step 507: The source gNB-CU-CP transmits, to the UE, a handover command, which is transmitted to the UE through an RRC reconfiguration request.

The source gNB-CU-CP transmits the handover command transmitted by the destination gNB-CU-CP to the UE.

For conditional handover, the configuration for conditional handover transmitted by the destination gNB-CU-CP to the UE may also carry the indication information of whether the destination base station supports PDU set handling. In the conditional handover, the source base station prepares a plurality of destination gNB-CU-CPs, each of which contains the indication information of whether the base station supports PDU set handling in the RRC message transmitted to the UE. After the UE receives the configuration for conditional handover, the UE can refer to the information of whether the candidate gNB-CU-CP supports PDU set handling and decide which of the candidate base stations to select as the destination base station.

Step 508: The source gNB-CU-CP (i.e., the first node) transmits an SN status transfer message to the destination gNB-CU-CP (i.e., the second node).

In a normal handover process, the source gNB-CU-CP may suspend the transmission and reception of data, stop allocating Packet Data Convergence Protocol (PDCP) sequence numbers to downlink service data units (SDUs), and stop transmitting uplink SDUs to the core network.

The message in step 508 carries an identification of a DRB and status information of a PDCP sequence number of the DRB, which contains an uplink COUNT value and a downlink COUNT value. After receiving this value, the destination base station, for example, allocates the PDCP sequence number contained in the DL COUNT value to the first downlink data packet that has not been allocated the PDCP sequence number. If the source base station accepts the uplink data forwarding required by the destination base station, the message may further contain a reception status of a lost or received uplink SDU.

Step 509: The second node (i.e. the destination gNB-CU-CP) transmits a bearer context modification request message to the user plane entity (i.e. the destination gNB-CU-UP).

The destination gNB-CU-CP transmits, to the destination gNB-CU-UP, a bearer context modification request message, which contains an identification of the UE at E1 interface, a session identification and/or a DRB identification for which data forwarding is to be carried out, and the PDCP sequence number status information corresponding to the DRB.

Step 510: The user plane entity (i.e. the destination gNB-CU-UP) transmits a bearer context modification response message to the second node (i.e. the destination gNB-CU-CP).

In an embodiment, the destination gNB-CU-UP transmits, to the destination gNB-CU-CP, a bearer context modification response message, which contains an identification of the UE at E1 interface, and may further contain the indication information of whether the destination gNB-CU-UP supports XR service in this step.

Step 511: The UE synchronizes with the destination cell and transmits a handover complete message to the destination gNB-CU-CP.

In case of conditional handover, the UE can refer to whether the destination cell/destination gNB-CU-CP supports PDU set handling when selecting the destination cell. When the UE has ongoing PDU set handling, it may select a gNB-CU-CP that supports PDU set handling as the destination gNB-CU-CP on the premise of satisfying the conditional handover.

Step 512: The destination gNB-CU-CP transmits a path switching request message to the core network AMF.

The path switching request message contains location information of the UE and a list of PDU sessions for switching to the destination gNB-CU-CP. The location information of the UE contains a unique identification of the cell where the UE is located and an identification of the tracking area where the UE is located. The specific information of the PDU sessions for switching to the destination gNB-CU-CP is contained in an N2 SM container, which contains an address of user plane and information of QoS flow.

If the destination base station supports PDU set handling, the message further contains the indication information that the destination base station supports PDU set handling, which can indicate that the QoS information corresponding to a certain PDU set is accepted in the QoS flow, for example, indicate that the PSBD is accepted, or the indication information is an explicit indication information that the destination base station supports PDU set handling, whereas not containing this information means that the destination base station does not support it, or indicates that the destination base station supports or does not support PDU set handling. The destination base station supporting means that the gNB-CU-CP, the gNB-CU-UP and the gNB-DU all support PDU set handling.

If the destination base station does not support PDU set handling, the message contains no indication information related to XR, or contains the indication information that the base station does not support PDU set handling. The destination base station not supporting means that one of the gNB-CU-CP, the gNB-CU-UP and the gNB-DU does not support PDU set handling.

The above indication information in this step can be transmitted from the destination gNB-CU-CP to the SMF through the N2 SM container, or be contained outside the SM container and transmitted to the AMF, which then transmits it to the SMF through step 307.

Step 513: The AMF transmits a path switching response message to the destination gNB-CU-CP.

The AMF transmits, for example, a response message to the destination gNB-CU-CP. The message contains the N2 SM container received from the SMF.

The path switching response message contains an identification of the UE at NG interface, bearer information of successful switching or an identification of PDU Session, and an N2 SM container which contains contents of SMF configuration, is transparent to the AMF, and contains information of a user plane allocated by the UPF, and information of QoS.

Step 514: The destination gNB-CU-CP transmits a UE context release request message to the source gNB-CU-CP.

After the UE switches to the destination gNB-CU-CP, the destination gNB-CU-CP may transmit a UE context release request message, requesting the source gNB-CU-CP to release the saved UE-related information and resources.

So far, the handover process of the above embodiment has been completed.

Through the above, the UE can move between an NG-RAN supporting PDU set and an NG-RAN not supporting PDU set, and can dynamically start the QoS parameter configuration and the user plane information transfer for data set, which improves the transmission performance of XR service data and satisfies the requirements of XR service.

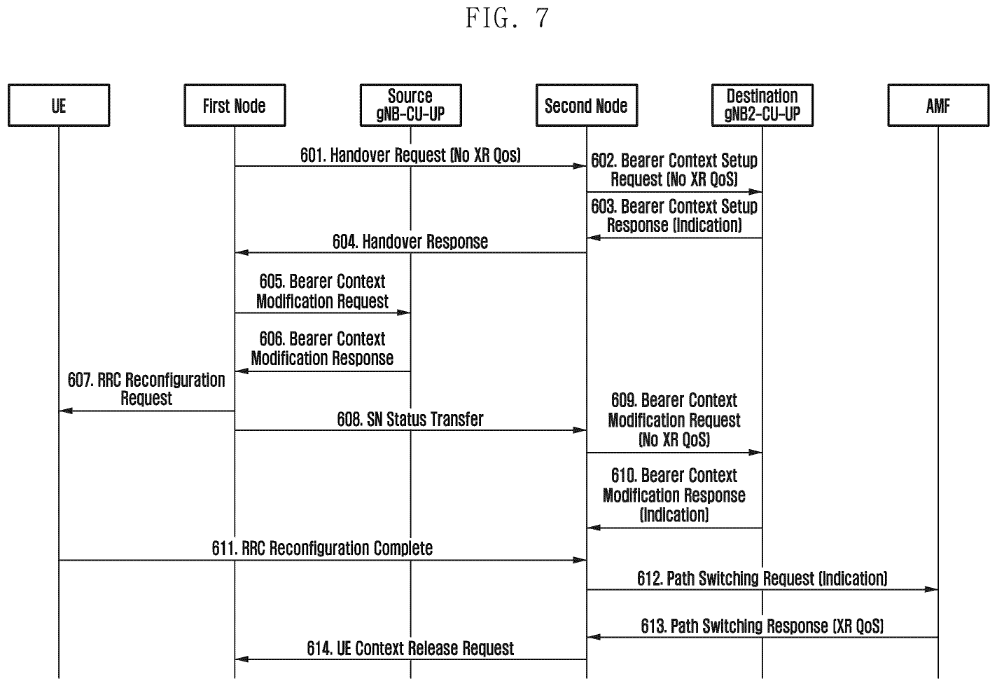

FIG. 7 is a schematic diagram for describing yet another process in which a user equipment (UE) moves from a first node to a second node according to an embodiment of the disclosure. Herein, the first node (i.e., the source base station serving the UE) does not support XR service, that is, the XR service is transferred as an ordinary service at the source base station. In this embodiment, the UE moves to the second node, that is, the destination base station, which may or may not support XR service. The first node and the second node are split base station structures.

The specific process of the embodiment of the disclosure is shown in FIG. 7. Referring to FIG. 7, the method of this embodiment may include one or more steps from step S601 to step S614.

Step 601: The first node transmits a handover request message to the second node.

The first node is the centralized control entity of the source base station (e.g., the source gNB-CU-CP), and decides to hand over, according to the measurement result of the UE, the UE to the second node, which is the centralized control entity of the destination base station (e.g., the destination gNB-CU-CP). The handover request message contains one or more of: an identification of a destination cell, and a list of ongoing PDU sessions by the UE, which contains PDU session identifications (IDs), a QoS flow ID, service quality requirements for QoS flow, and uplink data receiving address, such as a transport layer IP address and tunnel identification (TEID), which is allocated by a user plane node UPF in the core network. The message further contains the information of about data forwarding the first node, and the information about data forwarding contains a suggestion that data forwarding is needed for the uplink data and/or downlink data of a certain session or a certain DRB.

For the XR service, the source gNB-CU-CP considers the XR service as an ordinary service, thus the handover request message does not contain the information specific to XR.

Step 602: The second node transmits a bearer context setup request message to the destination user plane entity.

In an embodiment, the destination user plane entity may be the destination gNB-CU-UP, which is described below with the second node being the destination gNB-CU-CP and the destination user plane entity being the destination gNB-CU-UP as an example. The destination gNB-CU-CP transmits, to the destination gNB-CU-UP, a bearer context setup request message, which contains an identification of the UE at E1 interface, encryption information, an identification of service operator (PLMN ID), an identification of the UE in the access network (RAN ID), an identification of the distributed unit (DU) of the base station, and a list of PDU sessions to be set up. The list of PDU sessions contains a PDU session identification, S-NSSAI, encryption indication, and an uplink transport layer address, such as an IP address and TEID, which is allocated by the user plane node UPF of the core network for receiving uplink data. The list of PDU sessions further contains a list of DRBs to be set up, which contains DRB identification, a quality of service (QoS) of DRB, SDAP configuration, PDCP configuration, PDCP sequence number status information, Cell group information, and a list of QoS flows to be set up. The gNB-CU-CP decides the mapping of QoS flow to data wireless channel. The list of QoS flows contains identifications of QoS flows, QoS of QoS flow and so on.

The bearer context setup request message does not contain the information specific to XR.

Step 603: The destination gNB-CU-UP transmits a bearer setup response message to the destination gNB-CU-CP (i.e., the second node).

The destination gNB-CU-UP transmits a bearer context setup response message to the destination gNB-CU-CP. The message contains an identification of the UE at E1 interface, and a list of successfully setup PDU sessions, which contains identifications of PDU sessions, encryption result, and a downlink transport layer address which is allocated by the gNB-CU-UP for receiving downlink data transmitted by the core network. The message contains a list of successfully setup DRBs, which contains DRB identifications, information of DRB data forwarding, uplink user plane information of DRB which contains a user plane transport layer addresses, cell group identifications, etc. The uplink user plane address is allocated by the gNB-CU-CP for receiving uplink data transmitted by the DU.

If the destination gNB-CU-UP supports PDU set handling, the message in step 603 contains the indication information that the destination gNB-CU-UP supports PDU set handling, which is an explicit indication information that the destination gNB-CU-UP supports PDU set handling, whereas not containing this indication information means that the destination gNB-CU-UP does not support it, or indicates that the destination gNB-CU-UP supports or does not support PDU set handling.

In another embodiment, the destination gNB-CU-UP can get to know whether the conditional handover has been performed from the CHO indication contained in the bearer context setup request message. In case of conditional handover, the destination gNB-CU-UP response message may also carry the indication information of whether the destination gNB-CU-UP supports PDU set handling. The second node transmits it to the UE through the first node. In the conditional handover, the first node prepares a plurality of destination base stations, each of which contains the indication information of whether the base station supports PDU set handling in the RRC message transmitted to the UE. After the UE receives the configuration for conditional handover, the UE can refer to the information of whether the candidate base station supports PDU set handling and decide which of the candidate base stations to select as the destination base station.

The process from the destination gNB-CU-CP to the destination gNB-DU is omitted here. Similarly, the gNB-DU may implicitly indicate that the gNB-DU supports PDU set by containing the indication information of XR QoS parameter acceptance in the UE context setup response message, or indicate, through an explicit indication information, that the gNB-DU supports PDU set and/or does not support PDU set. The indication information of XR QoS parameter acceptance may indicate that the QoS corresponding to the PDU set of a certain XR service is accepted.

Step 604: The second node transmits a handover response message to the first node.

The destination gNB-CU-CP sets up resources corresponding to a session according to session-related information contained in the handover request message. The session-related information, for example, contains a session identification, and the session contains information of QoS flow, as well as a suggestion for data forwarding. According to the suggestion for forwarding, the destination gNB-CU-CP decides whether data forwarding is needed for the session and/or for the DRB, and if so, the destination gNB-CU-CP allocates a data forwarding address for the session or DRB.

The destination gNB-CU-CP transmits a handover response message to the source gNB-CU-CP. The message carries an identification of the UE over Xn interface, bearer information or PDU session information received at the destination gNB-CU-CP, data forwarding information, and a handover command message to be transmitted to the UE. The data forwarding information contains an identification of a QoS flow for which data forwarding is to be carried out, an uplink and/or downlink transport layer IP address and GTP tunnel identification corresponding to the PDU session, as well as an identification of a DRB for which data forwarding is to be carried out, and an uplink and/or downlink transport layer IP address and GTP tunnel identification corresponding to the DRB.

In case of conditional handover, the configuration for conditional handover transmitted by the destination gNB-CU-CP to the UE may carry the indication information of whether the destination gNB-CU-CP supports PDU set handling. In the conditional handover, the source base station prepares a plurality of destination base stations, each of which contains the indication information of whether the base station supports PDU set handling in the RRC message transmitted to the UE. After the UE receives the configuration for conditional handover, the UE can refer to the information of whether the candidate base station supports PDU set handling and decide which of the candidate base stations to select as the destination base station.

Step 605: The first node transmits a bearer context modification request message to a source user plane entity (e.g., the source gNB-CU-CP).

In an embodiment, the source gNB-CU-CP transmits, to the source gNB-CU-UP, a bearer context modification request message, which contains an identification of the UE at E1 interface, an identification of a session for which data forwarding is to be carried out, and data forwarding information, which contains the transport layer address and tunnel identification for the uplink and/or downlink data forwarding, and an identification of a QoS flow for which data forwarding is to be carried out.

Step 606: The source user plane entity transmits a bearer context modification request message to the first node.

The message, for example, contains an identification of the UE at E1 interface and a list of successfully modified PDU sessions, which contains session identifications, identifications of data radio bearer and PDCP sequence number status information. The PDCP sequence number status information contains a status of the received PDCP SDU, an uplink COUNT value and a downlink COUNT value. A COUNT value contains a PDCP SN and a hyperframe number (HFN number).

Step 607: The source gNB-CU-CP transmits, to the UE, a handover command, which is transmitted to the UE through an RRC reconfiguration request.

The source gNB-CU-CP transmits the handover command transmitted by the destination gNB-CU-CP to the UE.

For conditional handover, the configuration for conditional handover transmitted by the destination gNB-CU-CP to the UE may also carry the indication information of whether the destination base station supports PDU set handling. In the conditional handover, the source base station prepares a plurality of destination base stations, each of which contains the indication information of whether the base station supports PDU set handling in the RRC message transmitted to the UE. After the UE receives the configuration for conditional handover, the UE can refer to the information of whether the candidate base station supports PDU set handling and decide which of the candidate base stations to select as the destination base station.

Step 608: The source gNB-CU-CP transmits an SN status transfer message to the destination gNB-CU-CP.

In a normal handover process, the source gNB-CU-CP may suspend the transmission and reception of data, stop allocating Packet Data Convergence Protocol (PDCP) sequence numbers to downlink service data units (SDUs), and stop transmitting uplink SDUs to the core network.

The message in step 608 carries an identification of a DRB and PDCP sequence number status information of the DRB, which contains an uplink COUNT value and a downlink COUNT value. After receiving this value, the destination gNB-CU-CP allocates the PDCP sequence number contained in the DL COUNT value to the first downlink data packet that has not been allocated the PDCP sequence number. If the source base station accepts the uplink data forwarding required by the destination base station, the message may further contain the reception status of the lost or received uplink SDU.

Step 609: The second node transmits a bearer context modification request message to the destination user plane entity (e.g., the destination gNB-CU-UP).

In another embodiment, the destination gNB-CU-CP transmits, to the destination gNB-CU-UP, a bearer context modification request message, which contains an identification of the UE at E1 interface, a session identification and/or a DRB identification for which data forwarding is to be carried out, and the PDCP sequence number status information corresponding to the DRB.

Step 610: The destination user plane entity transmits a bearer context modification response message to the second node.

In yet another embodiment, the destination gNB-CU-UP transmits, to the destination gNB-CU-CP, a bearer context modification response message, which contains an identification of the UE at E1 interface. In this step, if the destination gNB-CU-UP supports PDU set handling, the message in step 603 contains the indication information that the destination gNB-CU-UP supports PDU set handling, which is an explicit indication information that the destination gNB-CU-UP supports PDU set handling, whereas not containing this indication information means that the destination gNB-CU-UP does not support it, or indicates that the destination gNB-CU-UP supports or does not support PDU set handling.

Step 611: The UE synchronizes with the destination cell and transmits a handover complete message to the destination gNB-CU-CP.

In case of conditional handover, the UE can refer to whether the destination cell/destination base station supports PDU set handling when selecting the destination cell. When the UE has ongoing XR services, it may select a base station that supports PDU set handling as the destination base station on the premise of satisfying the conditional handover.

Step 612: The destination gNB-CU-CP transmits a path switching request message to the core network AMF.

The path switching request message, for example, contains location information of the UE and a list of PDU sessions for switching to the destination base station. The location information of the UE contains a unique identification of the cell where the UE is located and an identification of the tracking area where the UE is located. The specific information of the PDU sessions for switching to the destination base station is contained in an N2 SM container, which contains an address of user plane and information of QoS flow.

If the destination base station supports PDU set handling, which means that the gNB-CU-CP, the gNB-CU-UP and the gNB-DU all support PDU set handling, then the message further contains the indication information that the destination base station supports PDU set handling, which is explicit indication information that the destination base station supports PDU set handling, whereas not contain this indication information means that the destination base station does not support it, or indicates whether the destination base station support PDU set handling.

If the destination base station does not support PDU set handling, which means that one of the gNB-CU-CP, the gNB-CU-UP and the gNB-DU does not support PDU set handling, then the message does not contain indication information related to PDU set, or contains indication information that the base station does not support PDU set handling.

The above indication information in this step can be transmitted from the base station to the SMF through the N2 SM container, or be contained outside the SM container and transmitted to the AMF, which then transmits it to the SMF through step 307.

Step 613: The AMF transmits a path switching response message to the destination gNB-CU-CP.

The AMF transmits a response message to the destination gNB-CU-CP. The message contains the N2 SM container received from the SMF. That is, before transmitting the path switching message, the AMF transmits a message to the SMF. As described in steps 407 to 410, when the SMF knows that the destination base station supports PDU set handling but the source base station does not support PDU set handling, the SMF may contain, in the N2 SM container transmitted to the AMF, relevant configuration information for PDU set, which contains a QoS flow identification of XR service, periodicity of XR data transmitted on a QoS flow, time of arrival of a data burst, duration of data survival, configuration for jitter, etc. The relevant configuration information contains QoS parameter configuration for packet data unit set of XR service, that is, it contains at least one piece of the following information: QoS flow ID, a type of PDU set, an identification of PDU set, PSDB, PDER, PSIHI. In this way, the destination gNB-CU-CP can get the specific configuration information for XR as soon as possible, and can schedule and handle the data according to the features of XR as soon as possible, which improves the performance of XR service and improves the customer satisfaction of XR service.

The relevant configuration information for PDU set can also be modified later through a separate session modification process, such as through a PDU session modification request message. In the later separate process, the SMF transmits the configuration for jitter of XR service and the QoS parameter configuration for packet data unit set of XR service to the destination gNB-CU-CP through the AMF.

The path switching response message contains an identification of the UE at NG interface, bearer information of successful switching or an identification of PDU Session, and an N2 SM container which contains contents of SMF configuration, is transparent to the AMF, and contains information of a user plane allocated by the UPF, and information of QoS.

Step 614: The destination gNB-CU-CP transmits a UE context release request message to the source gNB-CU-CP.

After the UE switches to the destination gNB-CU-CP, the destination gNB-CU-CP may transmit a UE context release request message, requesting the source gNB-CU-CP to release the saved UE-related information and resources.

So far, the handover process of the above embodiment has been completed.

Through the above embodiment, the UE can move between an NG-RAN supporting PDU set and an NG-RAN not supporting PDU set, and can dynamically start the QoS parameter configuration and the user plane information transfer for data set, which improves the transmission performance of XR service data and satisfies the requirements of XR service.

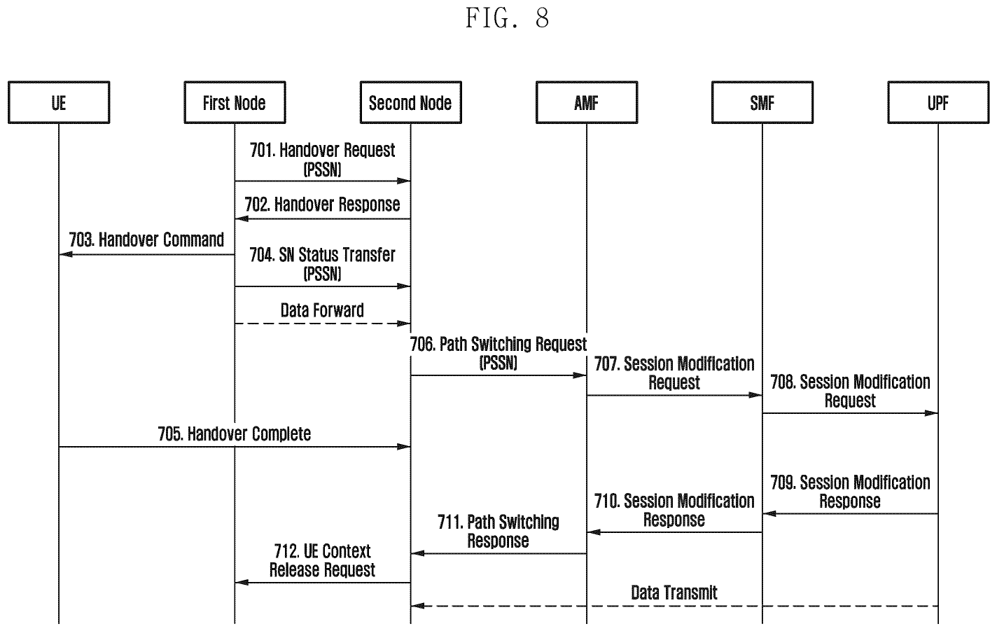

FIG. 8 is a schematic diagram for describing an Xn-based process in which a user equipment (UE) moves from a first node to a second node according to an embodiment of the disclosure. Herein, the first node is also the source base station serving the UE, the UE is configured with a session of XR service at the source base station and is receiving XR service, and the UE moves to the second node, that is, the destination base station. The first node and the second node are centralized base station structures. This embodiment provides how to provide an enhanced handover process for XR service.

The specific process of the embodiment of the disclosure is shown in FIG. 8. Referring to FIG. 8, the method of this embodiment may include one or more steps from step S701 to step S712.

Step 701: The first node transmits a handover request message to the second node.

In an embodiment, the first node is a source base station. The source base station decides to hand over the UE to the second node (the destination base station) according to a measurement result of the UE. The handover request message contains one or more of: an identification of a destination cell, and a list of ongoing PDU sessions by the UE, which contains PDU session identifications (IDs), a QoS flow ID, service quality requirements for QoS flow, and an uplink data receiving address, such as a transport layer IP address and tunnel identification (TEID), which is allocated by a user plane node UPF in the core network. The message contains information about data forwarding of the source base station, and the information about data forwarding contains a suggestion that data forwarding is needed for the uplink data and/or downlink data of a certain session or a certain DRB.

For XR service, the handover request message further contains periodicity of XR data transferred on a QoS flow, time of arrival of a data burst, duration of data survival, configuration for jitter, etc. The handover request further contains QoS parameter configuration for packet data unit set of XR service, that is, contains at least one piece of the following information: QoS flow ID, a type of PDU set, an identification of PDU set, PSDB, PDER, PSIHI.

When the first node initiates a handover request, the first node is transmitting a certain PDU set to the UE, but has not transmitted all PDUs contained in the whole PDU set to the UE. The first node has only transferred part of the PDUs that have been received, for example the first N PDUs of the PDU set M. Moreover, the first node finds that one or more PDUs of the first N PDUs are lost. The reason for the loss may be that the loss happens during the core network transmitting data to the first node, or during the first node transmitting data to the UE at the air interface. If the QoS parameter configuration for packet data unit set contains a PSIHI, and the PSIHI is set to “Yes”, that is, the PSIHI indicates that the usage of the PDU set by the application layer needs all PDUs of the PDU set, then the first node contains, in the handover request message, a PDU set sequence number, which is a sequence number of a PDU set that has not been completely received, or a sequence number of a PDU set that needs to be discarded, such as PSSN M, or indication information and PSSN, in which the indication information indicates that a data packet in the PDU set M has a loss, or indicates to discard a PDU of the PDU set M, where M is a natural number greater than 0. When the second node receives the information, the second node receives a GTP-U data packet from the core network, and can get to know the PDU set to which the received PDU belongs from the inclusion of the PSSN in the packet header. If the second node receives a PDU of the PDU set M, it will discard all the received PDUs belonging to the PDU set M.

In another implementation method, the second node notifies the core network UPF that a PDU of the PDU set M is lost, and notifies the UPF that it is not required to transmit all PDUs belonging to PDU set M. These methods are all carried out on the premise that the PSIHI indicates that the usage of PDU set by the application layer needs all PDUs of the PDU set, and the first method and the second method can be used in combination.

When the first node performs data forwarding, the first node gets to know that a PDU of the PDU set M has a loss, then the first node does not forward the PDU of the set M that has not been transmitted to the UE, and only forward, to the second node, the PDU that has no data loss and has not been transmitted to the UE.

Step 702: The second node transmits a handover response message to the first node.

The second node (i.e., the destination base station) sets up resources corresponding to a session according to session-related information contained in the handover request message. The session-related information, for example, contains a session identification, and the session contains information of QoS flow, as well as a suggestion for data forwarding. According to the suggestion for forwarding, the destination base station decides whether data forwarding is needed for the session and/or for the DRB, and if so, the destination base station allocates a data forwarding address for the session or DRB.

The destination base station transmits a handover response message to the source base station. The message carries an identification of the UE over Xn interface, bearer information or PDU session information accepted at the destination base station, data forwarding information, and a handover command message to be transmitted to the UE. The data forwarding information contains an identification of a QoS flow for which data forwarding is to be carried out, an uplink and/or downlink transport layer IP address and GTP tunnel identification corresponding to the PDU session, as well as an identification of a DRB for which data forwarding is to be carried out, and an uplink and/or a downlink transport layer IP address and GTP tunnel identification corresponding to the DRB. The data forwarding address is allocated by the destination base station.

Step 703: The source base station transmits a handover command to the UE.

In an embodiment, the source base station transmits, to the UE, the handover command transmitted by the destination base station, which is transmitted to UE through an RRC reconfiguration request message.

Step 704: The first node transmits an SN status transfer message to the second node.

The SN status transfer message is a message through which the source base station needs to transmit the transfer status of data on the source base station to the destination base station when the source needs to forward data to the destination. If there is no data forwarding, the SN status transfer message in step 704 may be a new message.

In a normal handover process, the source base station may suspend the transmission and reception of data, stop allocating Packet Data Convergence Protocol (PDCP) sequence numbers to downlink service data units (SDUs), and stop transmitting uplink SDUs to the core network.

The SN status transfer message carries an identification of a DRB, and an uplink COUNT value and/or a downlink COUNT value of the DRB. After receiving this value, the destination base station allocates the PDCP sequence number contained in the DL COUNT value to the first downlink data packet that has not been allocated the PDCP sequence number. The message may contain the reception status of the lost or received uplink SDU.

When the first node initiates an SN status transfer message or a new message, the first node is transmitting a certain PDU set to the UE, but has not transmitted all PDUs contained in the whole PDU set to the UE. The first node has only transferred part of the received PDUs, for example, the first N PDUs of the PDU set M, and the first node finds that one or more PDUs are lost among the first N PDUs, and the reason for the loss may be that the loss happens during the core network transmitting data to the first node, or during the first node transmitting data to the UE at the air interface. If the QoS parameter configuration for packet data unit set contains a PSIHI, and the PSIHI is set to “Yes”, that is, the PSIHI indicates that the usage of the PDU set by the application layer needs all PDUs of the PDU set, then the first node contains, in the SN status transfer message or the new message, a PDU set sequence number, which is a sequence number of a PDU set that has not been completely received, or a sequence number of a PDU set that needs to be discarded, such as PSSN M, or indication information and PSSN, in which the indication information indicates that a data packet in the PDU set M has a loss, or indicates to discard a PDU of the PDU set M, where M is a natural number greater than 0.

There are two implementation methods. In the first method, the second node discards the PDUs belonging to the PDU set M, in which when the second node receives a GTP-U data packet from the core network, it can get to know the PDU set to which the received PDU belongs from the PSSN contained in the packet header, and if the second node receives a PDU belonging to the PDU set M, it discards all the received PDUs belonging to the PDU set M. In the second method, the second node notifies the core network UPF that a PDU of the PDU set M is lost, and notifies the UPF that it is not required to transmit all PDUs belonging to PDU set M. These methods are all carried out on the premise that the PSIHI indicates that the usage of PDU set by the application layer needs all PDUs of the PDU set, and the first method and the second method can be used in combination.

When the first node performs data forwarding, the first node gets to know that a PDU of the PDU set M has a loss, then the first node does not forward the PDU of the set M that has not been transmitted to the UE, and only forward, to the second node, the PDU that has no data loss and has not been transmitted to the UE.

Step 705: The UE synchronizes with a destination cell and transmits a handover complete message to the second node.

Step 706: The second node transmits a path switching request message to the core network AMF.

The path switching request message, for example, contains location information of the UE and a list of PDU sessions for switching to the destination base station. The location information of the UE contains a unique identification of the cell where the UE is located and an identification of the tracking area where the UE is located. The specific information of the PDU sessions for switching to the destination base station is contained in an SM container, which is to be transmitted to the SMF, and is transparently forwarded by the AMF to the SMF. The SM container contains an address of user plane allocated by the destination base station, which is used to receive downlink data packets, and contains a list of accepted QoS flows.

According to the second method above, the path switching request message contains PDU set sequence number, which is a sequence number of a PDU set that has not been completely received, or a sequence number of a PDU set that needs to be discarded, such as PSSN M, or indication information and PSSN, in which the discarded PSSN M, or the indication information and PSSN are obtained from the first node in step 701 or step 704. The sequence number of PDU set, or the indication information and PSSN may be contained in the SM container or contained outside the SM container. The indication information indicates that a data packet in the PDU set M has a loss, or indicates to discard a PDU of the PDU set M. The AMF forwards the sequence number of PDU set, such as PSSN M, or the indication information and PSSN, to the SMF, which forwards the PSSN M, or the indication information and PSSN, to the UPF.

Step 707: The AMF transmits a session modification request message to the SMF.

In an embodiment, the AMF transmits, to the SMF, a message, which carries the above SM container, and the information in the container is parsed and saved by the SMF. The message may further contain the location information of the UE. Alternatively, the message may further contain the indication information that the destination base station supports XR.

According to the second method above, the session modification request message contains a PDU set sequence number, which is a sequence number of a PDU set that has not been completely received, or a sequence number of a PDU set that needs to be discarded, such as PSSN M, or indication information and PSSN, in which the PSSN M and the indication information may be contained in the SM container or contained outside the container. The indication information indicates that a data packet in the PDU set M has a loss, or indicates to discard a PDU of the PDU set M.

Step 708: The SMF transmits the session modification request message to the UPF.

The SMF transmits, to the UPF, the session modification request message, which contains the downlink data receiving address allocated by the destination base station, so that the UPF knows that the UE has handed over to a new base station and will transmit the data to the new base station.

According to the second method above, the session modification request message contains a PDU set sequence number, which is a sequence number of a PDU set that has not been completely received, or a sequence number of a PDU set that needs to be discarded, such as PSSN M, or indication information and PSSN. The UPF receives the PSSN M, or the indication information and PSSN. The UPF may not transmit all PDUs belonging to PSSN M to the new base station (or new gNB-CU-UP, or destination base station, or destination gNB-CU-UP, the same below), or when transmitting data to the new base station, the UPF starts from a complete PDU set, for example, the data of PSSN M is transmitted through a source base station, and starting from the data a new complete PDU set, the UPF transmits data to the destination base station. In this way, all PDUs contained in the PSSN M are transmitted to the source base station, which may decide, according to the situation, to discard the remaining data of PSSN M or to forward the data of PSSN M to the destination base station, which will continue to transmit to the UE. After transmitting all PDUs of the PSSN M to the source base station, and adding an end identification, the UPF transmits data to the destination base station from a complete PDU set.

Step 709: The UPF transmits a session modification response message to the SMF.

The UPF transmits a response message to the SMF. The message may contain the uplink data receiving address allocated by the UPF.

Step 710: The SMF transmits the session modification response message to the AMF.

The SMF transmits, for example, the response message to the AMF. The message may contain a SM container, which contains the uplink data receiving address allocated by the UPF, and the data receiving address contains the transport layer IP address and GTP tunnel identification. The container further contains the received information of QoS flow, and the alternative QoS parameters of QoS flow.

Step 711: The AMF transmits a path switching response message to the second node.

The AMF transmits a response message to the destination base station. The message contains the SM container received in step 710.

The path switching response message contains an identification of the UE at NG interface, bearer information of successful switching or an identification of PDU Session, and an SM container which contains contents of SMF configuration, is transparent to the AMF, and contains information of user plane allocated by the UPF, and information of QoS flow.

Step 712: The second node transmits a UE context release request message to the first node.

After the UE is handed over to the destination base station, the destination base station may transmit a UE context release request message to request the source base station to release the saved UE-related information and resources.

So far, the handover process of the above embodiment has been completed.

Through the above embodiment, when the UE moves, the transmission of XR data can be reduced, the resources for air interface can be saved, and the transmission efficiency for XR data can be improved.

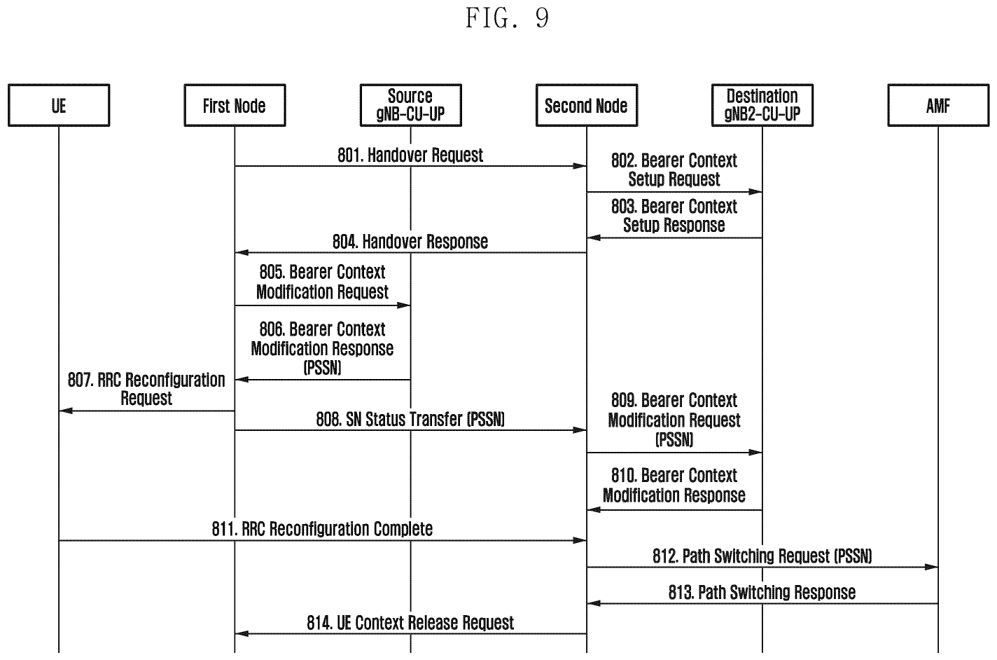

FIG. 9 is a schematic diagram for describing another Xn-based process in which a user equipment (UE) moves from a first node to a second node according to an embodiment of the disclosure. Herein, the first node is also the source base station serving the UE, the UE is configured with a session of XR service at the source base station and is receiving XR service, and the UE moves to the second node, that is, the destination base station. The first node and the second node are split base station structures. This embodiment provides how to provide an enhanced handover process for XR service.

The specific process of the embodiment of the disclosure is shown in FIG. 9. Referring to FIG. 9, the method of this embodiment may include one or more steps from step S801 to step S814.

Step 801: The first node transmits a handover request message to the second node.

The first node is the centralized control entity of the source base station (e.g., the source gNB-CU-CP), and the second node is the centralized control entity of the destination base station (e.g., the destination gNB-CU-CP). The source gNB-CU-CP decides to hand over, according to the measurement result of the UE, the UE to the destination gNB-CU-CP. The handover request message contains one or more of: an identification of a destination cell, and a list of ongoing PDU sessions by the UE, which contains PDU session identifications (IDs), a QoS flow ID, service quality requirements for QoS flow, and an uplink data receiving address, such as a transport layer IP address and tunnel identification (TEID), which is allocated by a user plane node UPF in the core network. The message further contains the information about data forwarding of the source gNB-CU-CP, and the information about data forwarding includes a suggestion that data forwarding is needed for the uplink data and/or downlink data of a certain session or a certain DRB.

For XR service, the handover request message further contains periodicity of XR data transferred on a QoS flow, time of arrival of a data burst, duration of data survival, configuration for jitter, etc. The handover request further contains QoS parameter configuration for packet data unit set of XR service, that is, contains at least one piece of the following information: QoS flow ID, a type of PDU set, an identification of PDU set, PSDB, PDER, PSIHI.

Step 802: The second node transmits a bearer context setup request message to the user plane entity.

In another embodiment, the user plane entity may be the destination gNB-CU-UP, which will be described below with the second node being the destination gNB-CU-CP and the user plane entity being the destination gNB-CU-UP as an example. The destination gNB-CU-CP transmits, to the destination gNB-CU-UP, a bearer context setup request message, which contains an identification of the UE at E1 interface, encryption information, an identification of service operator (PLMN ID), an identification of the UE in the access network (RAN ID), an identification of the distributed unit (DU) of the base station, and a list of PDU sessions to be set up. The list of PDU sessions contains PDU session identification, S-NSSAI, encryption indication, and an uplink transport layer address, such as IP address and TEID, which is allocated by the user plane node UPF of the core network for receiving uplink data. The list of PDU sessions further contains a list of DRBs to be set up, which contains DRB identification, quality of service (QoS) of DRB, SDAP configuration, PDCP configuration, PDCP sequence number status information, Cell group information, and a list of QoS flows to be set up. The gNB-CU-CP decides the mapping of QoS flow to data wireless channel. The list of QoS flows contains identifications of QoS flows, QoS of QoS flow and so on.

For XR service, the bearer context setup request message further contains periodicity of XR data transferred on a QoS flow, time of arrival of a data burst, duration of data survival, configuration for jitter, etc. The handover request further contains QoS parameter configuration for packet data unit set of XR service, that is, contains at least one piece of the following information: QoS flow ID, a type of PDU set, an identification of PDU set, PSDB, PDER, PSIHI.

Step 803: The destination gNB-CU-UP transmits a bearer setup response message to the second node.

In an embodiment, the destination gNB-CU-UP transmits a bearer context setup response message to the destination gNB-CU-CP. The message contains an identification of the UE at E1 interface, and a list of successfully setup PDU sessions, which contains identifications of PDU sessions, encryption results, and a downlink transport layer address which is allocated by the destination gNB-CU-UP for receiving downlink data transmitted by the core network. The message further contains a list of successfully setup DRBs, which contains DRB identifications, information of DRB data forwarding, uplink user plane information of DRB which contains user plane transport layer addresses, cell group identifications, etc. The uplink user plane address is allocated by the destination gNB-CU-CP for receiving uplink data transmitted by the DU. The message may further contain the QoS parameters of the accepted packet data unit set.

Step 804: The second node transmits a handover response message to the first node.

The destination gNB-CU-CP (i.e., the second node) sets up resources corresponding to a session according to session-related information contained in the handover request message. The session-related information contains a session identification, and the session contains information of QoS flow, as well as a suggestion for data forwarding. According to the suggestion for forwarding, the destination base station decides whether data forwarding is needed for the session and/or for the DRB, and if so, the destination base station allocates a data forwarding address for the session or DRB.

The destination gNB-CU-CP transmits, for example, a handover response message to the source gNB-CU-CP. The message carries an identification of the UE over Xn interface, bearer information or PDU session information accepted at the destination gNB-CU-CP, data forwarding information, and a handover command message to be transmitted to the UE. The data forwarding information contains an identification of a QoS flow for which data forwarding is to be carried out, an uplink and/or downlink transport layer IP address and GTP tunnel identification corresponding to the PDU session, as well as an identification of a DRB for which data forwarding is to be carried out, and an uplink and/or downlink transport layer IP address and GTP tunnel identification corresponding to the DRB.

Step 805: The first node transmits a bearer context modification request message to the source user plane entity.

The source gNB-CU-CP transmits, to the source gNB-CU-UP, a bearer context modification request message, which contains an identification of the UE at E1 interface, an identification of a session for which data forwarding is to be carried out, and data forwarding information, which contains the transport layer address and tunnel identification for the uplink and/or downlink data forwarding, and an identification of a QoS flow for which data forwarding is to be carried out. The message contains PDCP SN status request information, in which containing this information indicates that the source gNB-CU-UP needs to report the status of PDCP SN in the response message.

The message of step 805 may also indicate that the first node needs the source gNB-CU-UP to report the status of PDU set. Upon receiving this indication information, the source gNB-CU-UP needs to transmit the status of PDU set to the first node.

Step 806: The source gNB-CU-UP transmits a bearer context modification response message to the first node.

The message contains, for example, an identification of the UE at E1 interface and a list of successfully modified PDU sessions, which contains session identifications, identifications of data radio bearers and PDCP sequence number status information. The PDCP sequence number status information contains a status of the received PDCP SDU, an uplink COUNT value and a downlink COUNT value. A COUNT value contains a PDCP SN and a hyperframe number (HFN number).

If the message in 805 contains PDCP SN status request information, or contains indication information indicating the status of the PDU set reported by the source user plane, or the user plane sets up a session or a QoS flow of XR service, a certain PDU set is being transmitted to the UE on the source user plane, but all PDUs contained in the whole PDU set have not been transmitted to the UE, and the user plane has only transferred part of the PDUs that have been received, for example, the first N PDUs of the PDU set M. Moreover, the source user plane finds that one or more PDUs of the first N PDUs are lost. The reason for the loss may be that the loss happens during the core network transmitting data to the source user plane, or during the source user plane transmitting data to the UE at the air interface. If the QoS parameter configuration for packet data unit set contains a PSIHI, and the PSIHI is set to “Yes”, that is, the PSIHI indicates that the usage of the PDU set by the application layer needs all PDUs of the PDU set, then the source user plane entity contains, in the bearer context modification response message, a PDU set sequence number, which is a sequence number of a PDU set that has not been completely received, or a sequence number of a PDU set that needs to be discarded, such as PSSN M, or indication information and PSSN, in which the indication information indicates that a data packet in the PDU set M has a loss, or indicates to discard a PDU of the PDU set M. M is a natural number greater than 0.

Step 807: The first node transmits a handover command to the UE.

The first node transmits, to the UE, the handover command transmitted by the second node, which is transmitted to the UE through an RRC reconfiguration request message.

Step 808: The first node transmits an SN status transfer message to the second node.

The SN status transfer message is a message through which the source base station needs to transmit the transfer status of data on the source base station to the destination base station when the source needs to forward data to the destination. If there is no data forwarding, the SN status transfer message in step 808 may be a new message.

In a normal handover process, the source base station may suspend the transmission and reception of data, stop allocating Packet Data Convergence Protocol (PDCP) sequence numbers to downlink service data units (SDUs), and stop transmitting uplink SDUs to the core network.

The message in step 808 carries an identification of a DRB, an uplink COUNT value and a downlink COUNT value of the DRB. After receiving this value, the destination base station allocates the PDCP sequence number contained in the DL COUNT value to the first downlink data packet that has not been allocated the PDCP sequence number. The message may further contain the reception status of the lost or received uplink SDU.

The SN status transfer message or the new message contains a PDU set sequence number, which is a sequence number of a PDU set that has not been completely received, or a sequence number of a PDU set that needs to be discarded, such as PSSN M, or indication information and PSSN, in which the indication information indicates that a data packet in the PDU set M has a loss, or indicates to discard a PDU of the PDU set M. M is a natural number greater than 0.

There are two implementation methods. In the first method, the second node discards the PDUs belonging to the PDU set M, in which when the second node receives a GTP-U data packet from the core network, it can get to know the PDU set to which the received PDU belongs from the PSSN contained in the packet header, and if the second node receives a PDU belonging to the PDU set M, it discards all the received PDUs belonging to the PDU set M. The second method is that the second node notifies the core network UPF that a PDU of the PDU set M is lost, and notifies the UPF that it is not required to transmit all PDUs belonging to PDU set M. These methods are all carried out on the premise that the PSIHI indicates that the usage of PDU set by the application layer needs all PDUs of the PDU set, and the first method and the second method can be used in combination.

When the source base station user plane performs data forwarding, the source base station user plane gets to know that a PDU of the PDU set M has a loss, then the source base station user plane does not forward the PDU of the set M that has not been transmitted to the UE, and only forward, to the second node, the PDU that has no data loss and has not been transmitted to the UE.

According to the first method, the second node receives a sequence number M of a PDU set to be discarded, or the indication information and PSSN. If the second node receives a GTP-U data packet from the core network, it can get to know the PDU set to which the received PDU belongs through the inclusion of the PSSN in the packet header. If the second node receives a PDU of the PDU set M, it will discard all the received PDUs belonging to the PDU set M. When the base station is a split architecture, this method is implemented by the user plane of the second node, and the following steps are performed.

Step 809: The second node transmits a bearer context modification request message to the destination user plane entity.

In an embodiment, the destination gNB-CU-CP transmits, to the destination gNB-CU-UP, a bearer context modification request message, which contains an identification of the UE at E1 interface, a session identification and/or a DRB identification for which data forwarding is to be carried out, and the PDCP sequence number status information corresponding to the DRB.

The bearer context modification request message contains a sequence number M of a PDU set to be discarded, or the indication information and PSSN, in which the indication information indicates that a data packet in the PDU set M has a loss, or indicates to discard a PDU of the PDU set M. M is a natural number greater than 0.

When the destination gNB-CU-UP receives a GTP-U data packet from the core network, it can get to know the PDU set to which the received PDU belongs from the PSSN contained in the packet header, and if the destination gNB-CU-UP receives a PDU belonging to the PDU set M, it discards all the received PDUs belonging to the PDU set M.

Step 810: The destination user plane entity transmits a bearer context modification response message to the second node.

The destination gNB-CU-UP transmits, to the destination gNB-CU-CP, a bearer context modification response message, which contains an identification of the UE at E1 interface.

Step 811: The UE synchronizes with the destination cell and transmits a handover complete message to the destination base station.

Step 812: The second node transmits a path switching request message to the core network AMF.

The path switching request message contains, for example, location information of the UE and a list of PDU sessions for switching to the second node. The location information of the UE contains a unique identification of the cell where the UE is located and an identification of the tracking area where the UE is located. The specific information of the PDU sessions for switching to the second node is contained in an SM container, which contains an address of user plane allocated by the second node for receiving downlink data packets, and contains a list of accepted QoS flows.

According to the second method above, the path switching request message contains a PDU set sequence number, which is a sequence number of a PDU set that has not been completely received, or a sequence number of a PDU set that needs to be discarded, such as PSSN M, or indication information and PSSN, in which the PSSN M, or the indication information and PSSN is obtained from the first node in step 808. The PSSN M, or the indication information and PSSN may be contained in the SM container or contained outside the container. The indication information indicates that a data packet in the PDU set M has a loss, or indicates to discard a PDU of the PDU set M.

As shown in steps 707 to 710, the AMF may transmit the sequence number of PDU set, such as PSSN M, or the indication information and PSSN, to the UPF, which receives the PSSN M, or the indication information and PSSN. The UPF may not transmit all PDUs belonging to PSSN M to the new base station (or new gNB-CU-UP, or destination base station, or destination gNB-CU-UP, the same below), or when transmitting data to the new base station, the UPF starts from a complete PDU set, for example, the data of PSSN M is transmitted through a source base station, and starting from the data a new complete PDU set, the UPF transmits data to the destination base station. All PDUs contained in the PSSN M are transmitted to the source base station, which may decide, according to the situation, to discard the remaining data of PSSN M or to forward the data of PSSN M to the destination base station, which will continue to transmit to the UE. After transmitting all PDUs of the PSSN M to the source base station, and adding an end identification, the UPF transmits data to the destination base station from a complete PDU set. The process between the AMF and the UPF is the same as 707 to 710, and the steps of the core network are omitted here.

Step 813: The AMF transmits a path switching response message to the second node.

The AMF transmits a response message to the second node. The message contains the SM container received from the SMF.

The path switching response message contains, for example, an identification of the UE at NG interface, bearer information of successful switching or an identification of PDU Session, and an SM container which contains contents of SMF configuration, is transparent to the AMF, and contains information of user plane allocated by the UPF, and information of QoS.

Step 814: The destination base station transmits a UE context release request message to the source base station.

After the UE is handed over to the destination base station, the destination base station may transmit a UE context release request message to request the source base station to release the saved UE-related information and resources.

So far, the handover process of the above embodiment has been completed.

Through the above embodiment, when the UE moves, the transmission of XR data can be reduced, the resources for air interface can be saved, and the transmission efficiency for XR data can be improved.

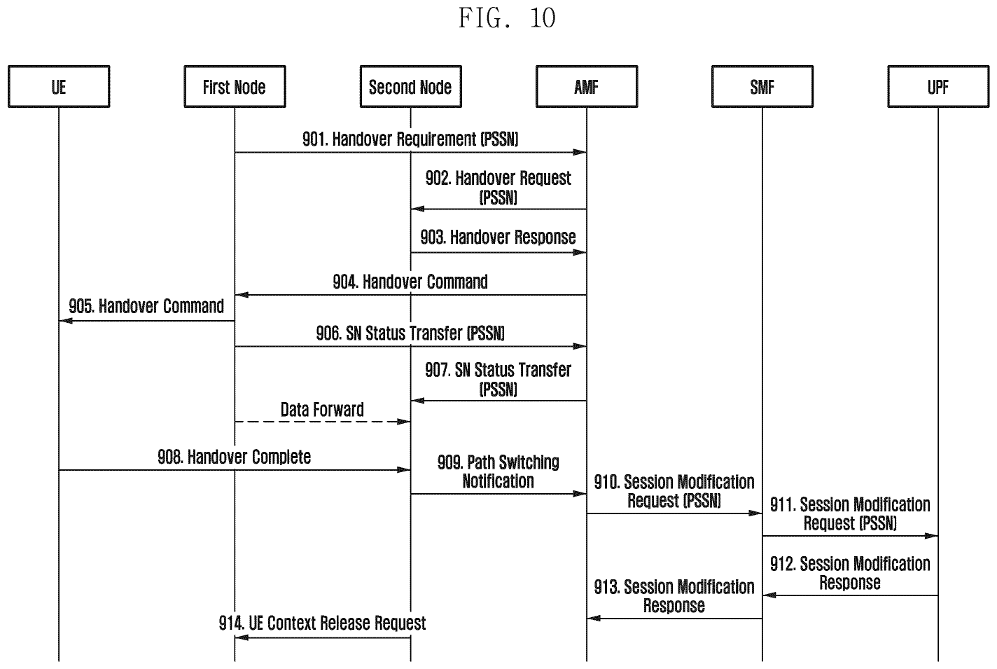

FIG. 10 is a schematic diagram for describing an NG-based process in which a user equipment (UE) moves from a first node to a second node according to an embodiment of the disclosure. Herein, the first node is also the source base station serving the UE, the UE is configured with a session of XR service at the source base station and is receiving XR service, and the UE moves to the second node, that is, the destination base station. The first node and the second node are centralized base station structures. This embodiment provides how to provide an enhanced handover process for XR service.

The specific process of the embodiment of the disclosure is shown in FIG. 10. Referring to FIG. 10, the method of this embodiment may include one or more steps from step S901 to step S914.

Step 901: The first node transmits a handover requirement message to the AMF.

The source base station decides to hand over the UE to the destination base station according to a measurement result of the UE. The handover request message contains one or more of: an identification of a destination cell, and a list of ongoing PDU sessions by the UE, which contains PDU session identifications (IDs), a QoS flow ID, service quality requirements for QoS flow, and an uplink data receiving address, such as a transport layer IP address and tunnel identification (TEID), which is allocated by a user plane node UPF in the core network. The message contains information about data forwarding of the source base station, and the information about data forwarding contains a suggestion that data forwarding is needed for the uplink data and/or downlink data of a certain session or a certain DRB.

For XR service, the handover requirement message further contains periodicity of XR data transferred on a QoS flow, time of arrival of a data burst, duration of data survival, configuration for jitter, etc. The handover request further contains QoS parameter configuration for packet data unit set of XR service, that is, contains at least one piece of the following information: QoS flow ID, a type of PDU set, an identification of PDU set, PSDB, PDER, PSIHI.

When the first node initiates a handover requirement, the first node is transmitting a certain PDU set to the UE, but has not transmitted all PDUs contained in the whole PDU set to the UE. The first node has only transferred part of the PDUs that have been received, for example, the first N PDUs of the PDU set M, and the first node finds that one or more PDUs of the first N PDUs are lost. The reason for the loss may be that the loss happens during the core network transmitting data to the first node, or during the first node transmitting data to the UE at the air interface. If the QoS parameter configuration for packet data unit set contains a PSIHI, and the PSIHI is set to “Yes”, that is, the PSIHI indicates that the usage of the PDU set by the application layer needs all PDUs of the PDU set, then the first node contains, in the handover requirement message, a sequence number M of a PDU set to be discarded, or indication information and PSSN, in which the indication information indicates that a data packet in the PDU set M has a loss, or indicates to discard a PDU of the PDU set M, where M is a natural number greater than 0. The information contained in the handover requirement message is transmitted through the AMF to the second node, that is, the destination base station. When the second node receives the information, the second node receives a GTP-U data packet from the core network, and get to know the PDU set to which the received PDU belongs from the inclusion of the PSSN in the packet header. If the second node receives a PDU of the PDU set M, it will discard all the received PDUs belonging to the PDU set M.

In another implementation method, the first node or the second node notifies the core network UPF that a PDU of the PDU set M is lost, and notifies the UPF that it is not required to transmit all PDUs belonging to PDU set M. These methods are all carried out on the premise that the PSIHI indicates that the usage of PDU set by the application layer needs all PDUs of the PDU set, and the first method and the second method can be used in combination.

When the first node performs data forwarding, the first node gets to know that a PDU of the PDU set M has a loss, then the first node does not forward the PDU of the set M that has not been transmitted to the UE, and only forward, to the second node, the PDU that has no data loss and has not been transmitted to the UE.

Step 902: The AMF transmits a handover request message to the second node.

The second node is the destination base station. The handover request message includes a source-to-destination transparent container, mobility management information (MM information) of N2, session management information (SM information) of N2, and UE wireless capability identification. The source-to-destination transparent container is received from the source base station, and forwarded by the AMF to the destination base station. The MM information contains, for example, encryption information, a mobility limitation list, etc. The SM information contains session-related information that the AMF receives from the SMF.

Step 903: The second node transmits a handover response message to the AMF.

The message contains a destination-to-source transparent container, accepted session list information, and non-accepted session list information.

Step 904: The AMF transmits a handover command message to the first node.

The handover command message contains a destination-to-source transparent container. The destination base station sets up resources corresponding to a session according to session-related information contained in the handover request message. The session-related information contains, for example, a session identification, and the session contains information of QoS flow, as well as a suggestion for data forwarding. According to the suggestion for forwarding, the destination base station decides whether data forwarding is needed for the session and/or for the DRB, and if so, the destination base station allocates a data forwarding address for the session or DRB.

The destination base station transmits a handover response message to the source base station. The message carries an identification of the UE over Xn interface, bearer information or PDU session information accepted at the destination base station, data forwarding information, and a handover command message to be transmitted to the UE. The data forwarding information contains an identification of a QoS flow for which data forwarding is to be carried out, an uplink and/or downlink transport layer IP address and GTP tunnel identification corresponding to the PDU session, as well as an identification of a DRB for which data forwarding is to be carried out, and an uplink and/or downlink transport layer IP address and GTP tunnel identification corresponding to the DRB. In case of direct data forwarding, the uplink and/or downlink transport layer IP address and GTP tunnel identification are allocated by the destination base station. In case of indirect data forwarding, the uplink and/or downlink transport layer IP address and GTP tunnel identification are allocated by the core network.

Step 905: The first node transmits a handover command to the UE.

The source base station transmits the handover command transmitted by the destination base station to the UE. The handover command is transmitted to the UE through an RRC reconfiguration request message.

Step 906: The first node transmits an uplink RAN status transfer message to the AMF.

In an embodiment, the uplink RAN status transfer message is a message through which the source base station needs to transmit the transfer status of data on the source base station to the destination base station when the source needs to forward data to the destination. If there is no data forwarding, the uplink or downlink RAN status transfer message in steps 906 and 907 may be a new message.

In a normal handover process, the source base station may suspend the transmission and reception of data, stop allocating Packet Data Convergence Protocol (PDCP) sequence numbers to downlink service data units (SDUs), and stop transmitting uplink SDUs to the core network.

The message in step 906 contains an RAN status transfer transparent container, which carries an identification of a DRB, an uplink COUNT value and/or a downlink COUNT value of the DRB. After receiving this value, the destination base station allocates the PDCP sequence number contained in the DL COUNT value to the first downlink data packet that has not been allocated the PDCP sequence number. If the source base station accepts the uplink data forwarding required by the destination base station, the message may further contain a reception status of a lost or received uplink SDU.

When the first node initiates an uplink RAN status transfer or a new message, a certain PDU set may have not be completely transferred, and only part of the received PDUs have been transferred, for example, the first N PDUs of the PDU set M have been transferred. The first node finds that one or more PDUs of the first N PDUs are lost, and the reason for the loss may be the loss happens during the core network transmitting data to the first node, or at the air interface. If the QoS parameter configuration for packet data unit set contains a PSIHI, and the PSIHI is set to “Yes”, that is, the PSIHI indicates that the usage of the PDU set by the application layer needs all PDUs of the PDU set, then the first node contains, in the uplink RAN status transfer message or the new message, a sequence number M of a PDU set to be discarded, or indication information and PSSN, in which the indication information indicates that a data packet in the PDU set M has a loss, or indicates to discard a PDU of the PDU set M. M is a natural number greater than 0. The information contained in the uplink RAN status message or the new message is transmitted to the second node by the AMF.

There are two implementation methods. The first method is that the second node discards the PDUs belonging to the PDU set M, in which when the second node receives a GTP-U data packet from the core network, it can get to know the PDU set to which the received PDU belongs from the PSSN contained in the packet header, and if the second node receives a PDU belonging to the PDU set M, it discards all the received PDUs belonging to the PDU set M. In the second method, the second node notifies the core network UPF that a PDU of the PDU set M is lost, and notifies the UPF that it is not required to transmit all PDUs belonging to PDU set M. These methods are all carried out on the premise that the PSIHI indicates that the usage of PDU set by the application layer needs all PDUs of the PDU set, and the first method and the second method can be used in combination.

When the first node performs data forwarding, the first node gets to know that a PDU of the PDU set M has a loss, then the first node does not forward the PDU of the set M that has not been transmitted to the UE, and only forward, to the second node, the PDU that has no data loss and has not been transmitted to the UE.

According to the first method, the second node receives a PDU set sequence number M and/or the indication information. If the second node receives a GTP-U data packet from the core network, it can get to know the PDU set to which the received PDU belongs through the inclusion of the PSSN in the packet header. If the second node receives a PDU of the PDU set M, it will discard all the received PDUs belonging to the PDU set M.

Step 907: The AMF transmits a RAN status transfer message to the second node.

The message carries the RAN status transfer transparent container of the message of step 906.

Step 908: The UE synchronizes with the destination cell and transmits a handover complete message to the destination base station.

Step 909: The second node transmits a path switching notification message to the core network AMF.

The path switching request message contains, for example, location information of the UE and a list of PDU sessions for switching to the destination base station. The location information of the UE contains a unique identification of the cell where the UE is located and an identification of the tracking area where the UE is located. The specific information of the PDU sessions for switching to the destination base station is contained in an SM container, which contains an address of user plane and information of QoS.

According to the second method above, the path switching notification message contains a PSSN M to be discarded, or the indication information and PSSN, in which the PSSN M and the indication are obtained from the first node in step 901 or step 906. The PSSN M and/or the indication information may be contained in the SM container or contained outside the container. The indication information indicates that a data packet in the PDU set M has a loss, or indicates to discard a PDU of the PDU set M. The AMF forwards the PSSN M and the indication information to the SMF, and the PSSN M and the indication information are forwarded to the UPF.

Step 910: The AMF transmits a session modification request message to the SMF.

The AMF transmits, to the SMF, a message carrying the above N2 SM container, and the information in the container is parsed and saved by the SMF. The message may further contain location information of the UE. Alternatively, the message may further contain indication information that the destination base station supports XR.

According to the second method above, the session modification request message contains a PDU set sequence number, which is a sequence number of a PDU set that has not been completely received, or a sequence number of a PDU set that needs to be discarded, such as PSSN M, or indication information and PSSN, in which the PSSN M and/or the indication information may be contained in the SM container or contained outside the container. The indication information indicates that a data packet in the PDU set M has a loss, or indicates to discard a PDU of the PDU set M.

Step 911: The SMF transmits the session modification request message to the UPF.

In an embodiment, the SMF transmits, to the UPF, the session modification request message, which contains the downlink data receiving address allocated by the destination base station, so that the UPF knows that the UE has handed over to a new base station and will transmit the data to the new base station.

According to the second method above, the session modification request message contains a PDU set sequence number, which is a sequence number of a PDU set that has not been completely received, or a sequence number of a PDU set that needs to be discarded, such as PSSN M, or indication information and PSSN. The UPF receives the PSSN M, or the indication information and PSSN. The UPF may not transmit all PDUs belonging to PSSN M to the new base station (or new gNB-CU-UP, or destination base station, or destination gNB-CU-UP, the same below), or when transmitting data to the new base station, the UPF starts from a complete PDU set, for example, the data of PSSN M is transmitted through a source base station, and starting from the data a new complete PDU set, the UPF transmits data to the destination base station. All PDUs contained in the PSSN M are transmitted to the source base station, which may decide, according to the situation, to discard the remaining data of PSSN M or to forward the data of PSSN M to the destination base station, which will continue to transmit to the UE. After transmitting all PDUs of the PSSN M to the source base station, and adding an end identification, the UPF transmits data to the destination base station from a complete PDU set.

Step 912: The UPF transmits a session modification response message to the SMF.

The UPF transmits a response message to the SMF. The message may contain the uplink data receiving address allocated by the UPF.

Step 913: The SMF transmits the session modification response message to the AMF.

The SMF transmits the response message to the AMF. The message may contain an N2 SM container, which contains the uplink data receiving address allocated by the UPF, and the data receiving address contains the transport layer IP address and the GTP tunnel identification. The container further contains the received information of QoS flow, and the alternative QoS parameters of QoS flow.

Step 914: The destination base station transmits a UE context release request message to the source base station.

After the UE is handed over to the destination base station, the destination base station may transmit a UE context release request message to request the source base station to release the saved UE-related information and resources.

So far, the process of the above embodiment has been completed.

Through the above embodiments, when the UE moves, the transmission of XR data can be reduced, the resources for air interface can be saved, and the transmission efficiency for XR data can be improved.

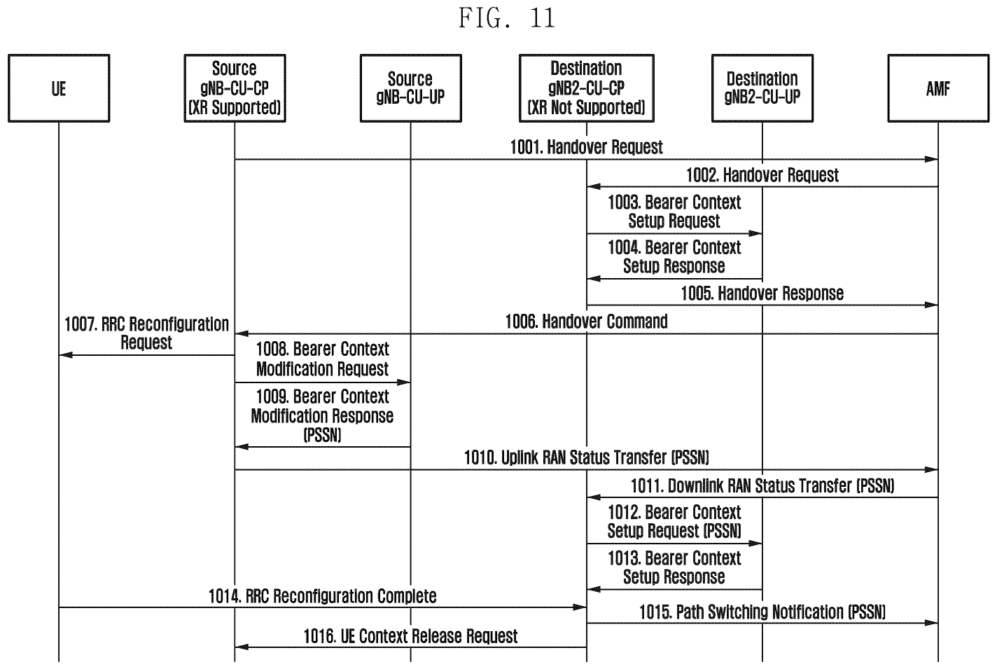

FIG. 11 is a schematic diagram for describing another NG-based process in which a user equipment (UE) moves from a first node to a second node according to an embodiment of the disclosure. Herein, the first node is also the source base station serving the UE, the UE is configured with a session of XR service at the source base station and is receiving XR service, and the UE moves to the second node, that is, the destination base station. The first node and the second node are split base station structures. This embodiment provides how to provide an enhanced handover process for XR service.

The specific process of the embodiment of the disclosure is shown in FIG. 11. Referring to FIG. 11, the method of this embodiment may include one or more steps from step S1001 to step S1016.

Step 1001: The first node transmits a handover requirement message to the AMF.

The first node is a centralized control entity of the source base station (e.g. source gNB-CU-CP). The source base station decides to hand over the UE to the destination base station according to a measurement result of the UE. The handover request message contains one or more of: an identification of a destination cell, and a list of ongoing PDU sessions by the UE, which contains PDU session identifications (IDs), a QoS flow ID, service quality requirements for QoS flow, and an uplink data receiving address, such as a transport layer IP address and tunnel identification (TEID), which is allocated by a user plane node UPF in the core network. The message contains information about data forwarding of the source base station, and the information about data forwarding contains a suggestion that data forwarding is needed for the uplink data and/or downlink data of a certain session or a certain DRB.

For XR service, the handover requirement message further contains periodicity of XR data transferred on a QoS flow, time of arrival of a data burst, duration of data survival, configuration for jitter, etc. The handover request further contains QoS parameter configuration for packet data unit set of XR service, that is, contains at least one piece of the following information: QoS flow ID, a type of PDU set, an identification of PDU set, PSDB, PDER, PSIHI.

Step 1002: The AMF transmits a handover request message to the second node.

The second node is the centralized control entity of the destination base station (e.g., the destination gNB-CU-CP). The handover request message contains a source-to-destination transparent container, mobility management information (MM information) of N2, session management information (SM information) of N2, and UE wireless capability identification. In an embodiment, the source-to-destination transparent container is received from the source gNB-CU-CP, and forwarded by the AMF to the destination gNB-CU-CP. The MM information contains encryption information, a mobility limitation list, etc. The SM information contains session-related information that the AMF receives from the SMF.

Step 1003: The second node transmits a bearer context setup request message to the destination user plane entity.

The destination user plane entity may be the destination gNB-CU-UP, which is described below with the second node being the destination gNB-CU-CP and the destination user plane entity being the destination gNB-CU-UP as an example. The destination gNB-CU-CP transmits, to the destination gNB-CU-UP, a bearer context setup request message, which contains an identification of the UE at E1 interface, encryption information, an identification of service operator (PLMN ID), an identification of the UE in the access network (RAN ID), an identification of the distributed unit (DU) of the base station, and a list of PDU sessions to be set up. The list of PDU sessions contains PDU session identification, S-NSSAI, encryption indication, and an uplink transport layer address, such as IP address and TEID, which is allocated by the user plane node UPF of the core network for receiving uplink data. The list of PDU sessions contains a list of DRBs to be set up, which contains DRB identifications, a quality of service (QoS) of DRB, SDAP configuration, PDCP configuration, PDCP sequence number status information, Cell group information, and a list of QoS flows to be set up. The gNB-CU-CP decides the mapping of QoS flow to data wireless channel. The list of QoS flows contains identifications of QoS flows, QoS of QoS flow and so on.

For XR service, the bearer context setup request message further contains periodicity of XR data transferred on a QoS flow, time of arrival of a data burst, duration of data survival, configuration for jitter, etc. The handover request contains QoS parameter configuration for packet data unit set of XR service, that is, contains at least one piece of the following information: QoS flow ID, a type of PDU set, an identification of PDU set, PSDB, PDER, PSIHI.

Step 1004: The destination gNB-CU-UP transmits a bearer setup response message to the destination gNB-CU-CP (i.e., the second node).

The destination gNB-CU-UP transmits a bearer context setup response message to the destination gNB-CU-CP. The message contains an identification of the UE at E1 interface, and a list of successfully setup PDU sessions, which contains identifications of PDU sessions, encryption results, and a downlink transport layer address which is allocated by the gNB-CU-UP for receiving downlink data transmitted by the core network. The message contains a list of successfully setup DRBs, which contains DRB identifications, information of DRB data forwarding, uplink user plane information of DRB which contains user plane transport layer addresses, cell group identifications, etc. The uplink user plane address is allocated by the gNB-CU-CP for receiving uplink data transmitted by the DU. The message may further contain QoS parameters of an accepted packet data unit set.

Step 1005: The second node transmits a handover response message to the AMF.

The message contains a destination-to-source transparent container, accepted session list information, and non-accepted session list information.

Step 1006: The AMF transmits a handover command message to the first node.

The handover command message contains a destination-to-source transparent container. The destination base station sets up resources corresponding to a session according to session-related information contained in the handover request message. In an embodiment, the session-related information contains a session identification, and the session contains information of QoS flow, as well as a suggestion for data forwarding. According to the suggestion for forwarding, the destination base station decides whether data forwarding is needed for the session and/or for the DRB, and if so, the destination base station allocates a data forwarding address for the session or DRB. The information is contained in the destination-to-source transparent container.

The handover command message also carries an RRC reconfiguration request message to be transmitted to the UE, which carries the configuration information after handover, and the RRC reconfiguration request message to be transmitted to the UE is contained in a destination-to-source transparent container. The data forwarding information contains, for example, an identification of a QoS flow for which data forwarding is to be carried out, an uplink and/or downlink transport layer IP address and GTP tunnel identification corresponding to the PDU session, as well as an identification of a DRB for which data forwarding is to be carried out, and an uplink and/or downlink transport layer IP address and GTP tunnel identification corresponding to the DRB. In case of direct data forwarding, the uplink and/or downlink transport layer IP address and GTP tunnel identification are allocated by the destination base station. In case of indirect data forwarding, the uplink and/or downlink transport layer IP address and GTP tunnel identification are allocated by the core network.

Step 1007: The first node transmits a handover command to the UE.

The source gNB-CU-CP transmits the RRC reconfiguration request message transmitted by the destination base station to the UE.

Step 1008: The first node transmits a bearer context modification request message to the source user plane entity (i.e. the source gNB-CU-UP).

The source gNB-CU-CP transmits, to the source gNB-CU-UP, a bearer context modification request message, which contains an identification of the UE at E1 interface, an identification of a session for which data forwarding is to be carried out, and data forwarding information, which contains the transport layer address and tunnel identification for the uplink and/or downlink data forwarding, and an identification of a QoS flow for which data forwarding is to be carried out. The message contains PDCP SN status request information, in which containing this information indicates that the source user plane needs to report the status of PDCP SN in the response message.

The message in step 1008 may also indicate that the first node needs the source user plane to report the status of PDU set. Upon receiving this indication information, the source user plane needs to transmit the status of PDU set to the first node.

Step 1009: The source user plane entity transmits a bearer context modification response message to the first node.

In an embodiment, the message contains an identification of the UE at E1 interface and a list of successfully modified PDU sessions, which contains session identifications, identifications of data radio bearer and PDCP sequence number status information. The PDCP sequence number status information contains a status of the received PDCP SDU, an uplink COUNT value and a downlink COUNT value. A COUNT value contains a PDCP SN and a hyperframe number (HFN number).

If the message in 1008 contains PDCP SN status request information, or contains indication information that the user plane needs to report the status of PDU set, or the user plane has set up a session or a QoS flow of XR service, a certain PDU set has not been transferred on the user plane, and only part of the received PDUs have been transferred, such as the first N PDUs of the PDU set M have been transferred. Moreover, the user plane entity finds that one or more PDUs of the first N PDUs are lost. The reason for the loss may be that the loss happens during the core network transmitting data to the first node, or at the air interface. If the QoS parameter configuration for packet data unit set contains a PSIHI, and the PSIHI is set to “Yes”, that is, the PSIHI indicates that the usage of the PDU set by the application layer needs all PDUs of the PDU set, then the user plane entity contains, in the bearer context modification response message, a sequence number M of a PDU set to be discarded, or indication information and PSSN, in which the indication information indicates that a data packet in the PDU set M has a loss, or indicates to discard a PDU of the PDU set M. M is a natural number greater than 0.

Step 1010: The first node transmits an uplink RAN status transfer message to the AMF.

The uplink RAN status transfer message is a message through which the source base station needs to transmit the transfer status of data on the source base station to the destination base station when the source needs to forward data to the destination. If there is no data forwarding, the uplink or downlink RAN status transfer message in steps 1010 and 1011 may be a new message.

In a normal handover process, the source gNB-CU-CP may suspend the transmission and reception of data, stop allocating Packet Data Convergence Protocol (PDCP) sequence numbers to downlink service data units (SDUs), and stop transmitting uplink SDUs to the core network

The message in step 1010 contains a RAN status transfer transparent container, which carries an identification of a DRB, an uplink COUNT value and a downlink COUNT value of the DRB. After receiving this value, the destination base station allocates the PDCP sequence number contained in the DL COUNT value to the first downlink data packet that has not been allocated the PDCP sequence number. If the source base station accepts the uplink data forwarding required by the destination base station, the message may further contain a reception status of a lost or received uplink SDU.

When the first node initiates an uplink RAN status transfer or a new message, a certain PDU set may not have been completely transferred, and only part of the received PDUs have been transferred, for example, the first N PDUs of the PDU set M have been transferred. Moreover, the first node finds that one or more PDUs of the first N PDUs are lost, and the reason for the loss may be the loss happens during the core network transmitting data to the first node, or at the air interface. If the QoS parameter configuration for packet data unit set includes a PSIHI, and the PSIHI is set to “Yes”, that is, the PSIHI indicates that the usage of the PDU set by the application layer needs all PDUs of the PDU set, then the first node contains, in the uplink RAN status transfer message or the new message, a sequence number M of a PDU set to be discarded, or the indication information and PSSN, in which the indication information indicates that a data packet in the PDU set M has a loss, or indicates to discard a PDU of the PDU set M. M is a natural number greater than 0.

There are two implementation methods. In the first method, the second node discards the PDUs belonging to the PDU set M, in which when the second node receives a GTP-U data packet from the core network, it can get to know the PDU set to which the received PDU belongs from the PSSN contained in the packet header, and if the second node receives a PDU belonging to the PDU set M, it discards all the received PDUs belonging to the PDU set M. In the second method, the second ode notifies the core network UPF that a PDU of the PDU set M is lost, and notifies the UPF that it is not required to transmit all PDUs belonging to PDU set M. These methods are all carried out on the premise that the PSIHI indicates that the usage of PDU set by the application layer needs all PDUs of the PDU set, and the first method and the second method can be used in combination.

When the first node performs data forwarding, the first node gets to know that a PDU of the PDU set M has a loss, then the first node does not forward the PDU of the set M that has not been transmitted to the UE, and only forward, to the second node, the PDU that has no data loss and has not been transmitted to the UE.

According to the first method, the second node receives a sequence number M of a PDU set to be discarded and/or the indication information. If the second node receives a GTP-U data packet from the core network, it can get to know the PDU set to which the received PDU belongs through the inclusion of the PSSN in the packet header. If the second node receives a PDU of the PDU set M, it will discard all the received PDUs belonging to the PDU set M.

Step 1011: The AMF transmits a downlink RAN status transfer message to the second node.

The message carries the RAN status transfer transparent container of the message of step 1010. If there is no data forwarding, the message of step 1011 may be a new message.

Step 1012: The second node transmits a bearer context modification request message to the destination user plane entity.

In another embodiment, the destination gNB-CU-CP transmits, to the destination gNB-CU-UP, a bearer context modification request message, which contains an identification of the UE at E1 interface, a session identification and/or a DRB identification for which data forwarding is to be carried out, and the PDCP sequence number status information corresponding to the DRB.

The bearer context modification request message contains a sequence number of a PDU set to be discarded, such as PSSN M, or the indication information and PSSN, in which the indication information indicates that a data packet in the PDU set M has a loss, or indicates to discard a PDU of the PDU set M. M is a natural number greater than 0.

When the destination gNB-CU-UP receives a GTP-U data packet from the core network, it can get to know the PDU set to which the received PDU belongs from the PSSN contained in the packet header, and if the destination gNB-CU-UP receives a PDU belonging to the PDU set M, it discards all the received PDUs belonging to the PDU set M.

Step 1013: The destination user plane entity transmits a bearer context modification response message to the second node.

The destination gNB-CU-UP transmits a bearer context modification response message to the destination gNB-CU-CP, containing an identification of the UE at E1 interface.

Step 1014: The UE synchronizes with the destination cell and transmits a handover complete message to the destination base station.

Step 1015: The second node transmits a path switching notification message to the core network AMF.

The path switching request message contains, for example, location information of the UE and a list of PDU sessions for switching to the destination base station. The location information of the UE contains a unique identification of the cell where the UE is located and an identification of the tracking area where the UE is located. The specific information of the PDU sessions for switching to the destination base station is contained in an SM container, which contains an address of user plane and information of QoS flow.

According to the second method above, the path switching notification message contains a PDU set sequence number, which is a sequence number of a PDU set that has not been completely received, or a sequence number of a PDU set that needs to be discarded, such as PSSN M, or indication information and PSSN, in which the PSSN M and/or the indication are obtained from the first node in step 1011. The PSSN M and/or the indication information may be contained in the SM container or contained outside the container. The indication information indicates that a data packet in the PDU set M has a loss, or indicates to discard a PDU of the PDU set M.

As shown in steps 910 to 913, the AMF may transmit the PSSN M that needs to be discarded, or the indication information and PSSN to the UPF, which receives the PSSN M that needs to be discarded, or the indication information and PSSN. The UPF may not transmit all PDUs belonging to PSSN M to the new base station (or new gNB-CU-UP, or destination base station, or destination gNB-CU-UP, the same below), or when transmitting data to the new base station, the UPF starts from a complete PDU set, for example, the data of PSSN M is transmitted through a source base station, and starting from the data a new complete PDU set, the UPF transmits data to the destination base station. In this way, all PDUs contained in the PSSN M are transmitted to the source base station, which may decide, according to the situation, to discard the remaining data of PSSN M or to forward the data of PSSN M to the destination base station, which will continue to transmit to the UE. After transmitting all PDUs of the PSSN M to the source base station, and adding an end identification, the UPF transmits data to the destination base station from a complete PDU set. The process between the AMF and the UPF is the same as 910 to 913, and the steps of the core network are omitted here.

Step 1016: The second node transmits a UE context release request message to the source base station.

After the UE is handed over to the destination base station, the destination gNB-CU-CP may transmit a UE context release request message to request the source base station to release the saved UE-related information and resources.

So far, the process of the above embodiment has been completed.

Through the above embodiments, when the UE moves, the transmission of XR data can be reduced, the resources for air interface can be saved, and the transmission efficiency for XR data can be improved.

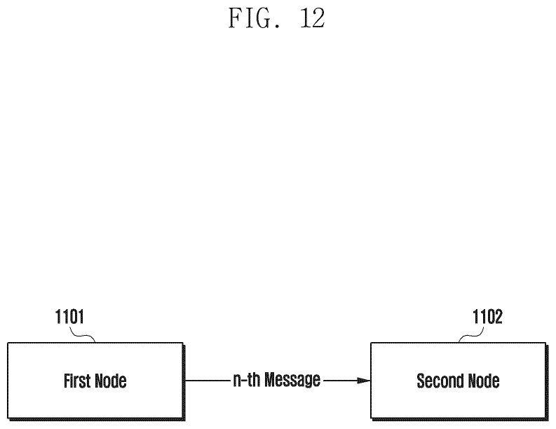

FIG. 12 is a schematic diagram for describing that a first node transmits a message to a second node for controlling data transfer according to an embodiment of the disclosure. The specific process is shown in FIG. 12.

Step 1101: The first node transmits the n-th message to the second node.

The first node can be a base station, a source base station, a source gNB-CU-UP, a source gNB-CU-CP, an AMF, an SMF, or a UPF, etc. The second node can be a base station, a destination base station, a gNB-CU-UP, a source gNB-CU-CP, a destination gNB-CU-CP, an AMF, an SMF, or a UPF, etc.

The n-th message may be a message of the control plane or a message of the user plane. The message of the user plane may be information contained in the GTP-U header.

If the n-th message is a message of the control plane, the message may carry a PDU set sequence number. The PDU set sequence number is a sequence number of a PDU set that has not been completely received, or a sequence number of a PDU set that needs to be discarded. When being located at the first node, the UE is configured with XR service. The first node is transmitting a certain PDU set to the UE, but has not transmitted all PDUs contained in the whole PDU set to the UE. The first node has only transferred part of the PDUs that have been received, for example, the first N PDUs of the PDU set M. Moreover, the first node finds that one or more PDUs of the first N PDUs are lost, and the reason for the loss may be that the loss happens during the core network transmitting data to the first node, or during the first node transmitting data to the UE at the air interface. If the QoS parameter configuration for packet data unit set contains a PSIHI, and the PSIHI is set to “Yes”, that is, the PSIHI indicates that the usage of the PDU set by the application layer needs all PDUs of the PDU set, then the first node transmits the message of the control plane to the second node. The message contains a sequence number of a PDU set to be discarded, such as PSSN M, or the indication information and PSSN, in which the indication information indicates that a data packet in the PDU set M has a loss, or indicates to discard a PDU of the PDU set M, where M is a natural number greater than 0.

The first node receives, from another node, a message, which contains a sequence number of a PDU set to be discarded, such as PSSN M, or the indication information and PSSN, in which the indication information indicates that a data packet in the PDU set M has a loss, or indicates to discard a PDU of the PDU set M, where M is a natural number greater than 0. The first node transmits the received PSSN, or the indication information and PSSN, to the second node.

Herein, the first node and the second node can be one of the following combinations, while other combinations will not be excluded:

The first node can be a base station, and the second node can be an AMF or an SMF.

The first node can be a source base station, and the second node can be an AMF or an SMF.

The first node can be a destination base station, and the second node can be an AMF or an SMF.

The first node can be a source base station, and the second node can be a destination base station.

The first node can be a destination gNB-CU-CP, and the second node can be a destination gNB-CU-UP.

The first node can be a source gNB-CU-UP, and the second node can be a source gNB-CU-CP.

The first node can be an AMF, and the second node can be a source SMF.

The first node can be an SMF, and the second node can be a UPF.

The first node can be a base station, and the second node can be a UPF.

The first node can be a gNB-CU-UP, and the second node can be a UPF.

If the n-th message is a message of the user plane, the first node is a gNB-CU-UP, or a base station, the second node is a UPF, the first node transmits, to the second node, the information of the user plane, which may be contained in the GTP-U header. The information of the user plane contains a sequence number of PDU set (PSSN), which is a sequence number of a PDU set to be discarded, and further contains the indication information indicating whether the PSSN exists in the user plane information or not. Specifically, the information of the user plane may be contained in the uplink PDU session information, which contains a PSSN indication (PSSN Ind) and a PSSN.

If the n-th message is a message of the control plane, the message indicates a path switching. The switching process is carried out by the UE, and after the switching process is completed, that is, the UE accesses the destination cell, the n-th message notifies the completion of the switching and notifies that the data transfer path is switched from the source to the destination. In an example, the message may be a handover notification during Ng handover, a path switching request message during Xn handover, or other messages. The message is transmitted to the AMF by the destination base station, and the AMF forwards the information in the message to the UPF through the SMF. The message may contain the downlink data receiving address information allocated by the destination base station.

Step 1102: The second node takes further operations.

The second node can be a base station, a destination base station, a destination gNB-CU-UP, a gNB-CU-CP, a destination gNB-CU-CP, an AMF, an SMF, or a UPF.

The further operations may be one of:

The second node receives a sequence number M of a PDU set to be discarded and/or the indication information. If the second node receives a data packet of GTP-U from the third node, it can get to know the PDU set to which the received PDU belongs through the inclusion of the PSSN in the packet header. If the second node receives a PDU of the PDU set M, it will discard all the received PDUs belonging to the PDU set M. Herein, the third node can be a UPF, and the second node can be a gNB-CU-UP.

The second node forwards the received n-th message or forwards the information received from the n-th message to the fourth node. The second node transmits a message to the fourth node, which can be a base station, a destination base station, a destination gNB-CU-UP, a gNB-CU-CP, a destination gNB-CU-CP, an AMF, an SMF, or an UPF. The message contains a PDU set sequence number, which is a sequence number of a PDU set that has not been completely received, or a sequence number of a PDU set that needs to be discarded, or indication information and PSSN, wherein the indication information indicates that a data packet in the PDU set M has a loss, or indicates to discard a PDU of the PDU set M, where M is a natural number greater than 0.

The second node may not transmit all PDUs belonging to PSSN M to the source gNB-CU-UP according to the PDU set sequence number M, or the indication information and PSSN. The gNB-CU-UP can be the destination gNB-CU-UP during the handover, or the source gNB-CU-UP, or the gNB-CU-UP serving the UE that has not initiated the handover process of the UE and is currently transmitting data to the UE. Herein, the second node can be a UPF. If the n-th message is a message of the user plane, the first node can be the gNB-CU-UP.

When the second node (at this time, the second node is a UPF) transmits data to the fifth node (the fifth node can be the destination base station or the destination gNB-CU-UP), it starts from a complete PDU set. For example, when the second node receives the n-th message carrying a PDU set sequence number M, it can get to know that the data of PSSN M has a loss, and from the data of the next complete PDU set (M+1), the UPF starts transmitting the data belonging to the new PDU set to the destination base station or the destination gNB-CU-UP.

In another embodiment, when the second node receives the n-th message, it can get to know that the data transmission path has been switched from the source to the destination node (the fifth node), and it can get to know that at the data receiving address of the destination node, which is the destination base station or the destination gNB-CU-UP, when the second node transmits data to the fifth node, it starts from a complete PDU set, for example, the data of PSSN A has been partially transmitted to the source base station before receiving the n-th message, and after receiving the n-th message, the second node continues to transmit the PSSN A data to the source base station or the source gNB-CU-UP, until all PDUs belonging to PSSN A are transmitted, then from the data of the next new complete PDU set (A+1), the UPF starts to transmit the data belonging to the new PDU set to the destination base station or the destination gNB-CU-UP. In this way, all PDUs contained in the PSSN A are transmitted to the source gNB-CU-UP, which may decide, according to the situation such as whether there is a data loss or not, to discard the remaining data of PSSN A, or to forward the data of PSSN A to the destination node, and continue to be transmitted by the destination node to the UE.

Through the above embodiment, when the UE moves, the transmission of XR data can be reduced, the resources for air interface can be saved, and the transmission efficiency for XR data can be improved.

It should be noted that the above FIG. 12 can be used in combination with FIGS. 8, 9, 10, and 11, and the node names need to be modified adaptively when being combined.

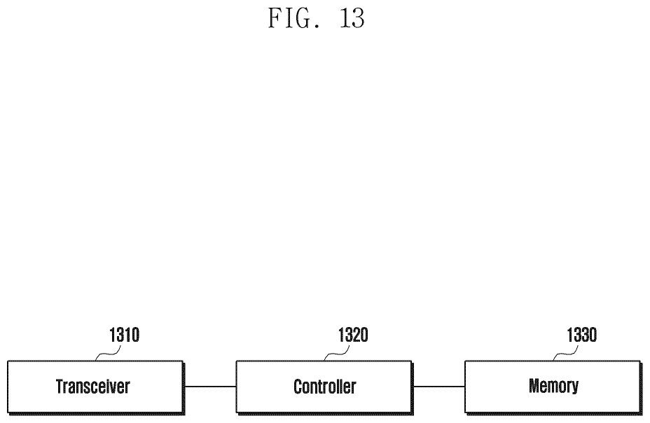

FIG. 13 is a block diagram of a network node according to an embodiment of the disclosure.

The network node according to the disclosure includes a transceiver 1310, a controller 1320 and memory 1330. The transceiver 1310, the controller 1320 and the memory 1330 are configured to perform the operations of the methods and/or embodiments of the disclosure. Although the transceiver 1310, the controller 1320 and the memory 1330 are shown as separate entities, they may be implemented as a single entity, such as a single chip. The transceiver 1310, the controller 1320 and the memory 1330 may be electrically connected or coupled to each other. The transceiver 1310 may transmit and receive signals to and from other network nodes, such as UE, MN, SN, S-SN, T-SN, other candidate T-SN or core network node. The controller 1320 may include one or more processing units, and may control the UE to perform the operations and/or functions according to one of the above embodiments. The memory 1130 may store instructions for implementing the operations and/or functions of one of the above embodiments described.

Those skilled in the art will understand that the illustrative embodiments described above are described herein and are not intended to be limiting. It should be understood that any two or more of the embodiments disclosed herein can be combined in any combination. In addition, other embodiments can be utilized and other changes can be made without departing from the spirit and scope of the subject matter presented herein. It will be readily understood that aspects of the disclosure, as generally described herein and shown in the accompanying drawings, can be arranged, substituted, combined, separated and designed in various different configurations, all of which are contemplated herein.

Those skilled in the art will understand that the various illustrative logical blocks, modules, circuits, and steps described in the application can be implemented as hardware, software, or a combination of both. In order to clearly illustrate this interchangeability between hardware and software, various illustrative components, blocks, modules, circuits, and steps are generally described above in the form of their function set. Whether such a function set is implemented as hardware or software depends on the specific application and the design constraints imposed on the overall system. Skilled people can implement the described function set in different ways for each specific application, but such design decisions should not be interpreted as causing a departure from the scope of the application.

The various illustrative logic blocks, modules, and circuits described in the application can be implemented in a general-purpose processor, a Digital Signal Processor (DSP), an Application Specific Integrated Circuit (ASIC), a Field Programmable Gate Array (FPGA) or other programmable logic devices, discrete gate or transistor logic, discrete hardware component, or any combination thereof designed to perform the functions described herein. A general-purpose processor may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors cooperating with a DSP core, or any other such configuration.

The steps of the method or technique described in the application can be embodied directly in hardware, in a software module executed by a processor, or in a combination of both. Software modules may reside in RAM memory, flash memory, ROM memory, erasable programmable ROM (EPROM) memory, electrically erasable programmable ROM (EEPROM) memory, register, hard disk, removable disk, or any other form of storage media known in the art. A storage medium is coupled to a processor to enable the processor to read and write information from/to the storage medium. In the alternative, the storage medium may be integrated into the processor. The processor and storage medium may reside in an ASIC. The ASIC may reside in the UE. In the alternative, the processor and the storage medium may reside in the UE as discrete components.

In one or more designs, the described functions can be implemented in hardware, software, firmware, or any combination thereof. If implemented in software, each function can be stored on or transferred by a computer-readable medium as one or more instructions or codes. Computer-readable media include both computer storage media and communication media, which includes any media that facilitates the transfer of computer programs from one place to another. The storage medium may be any available medium that can be accessed by a general-purpose or special-purpose computer.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments of thereof, it will be understood by those skilled in the art that various changes in form and details may be made therein without departing from the spirit and scope of the disclosure as defined by the appended claims and their equivalents.

What is claimed is:

1. A method performed by a first node in a wireless communication system, the method comprising:
transmitting, to a second node, a handover request message comprising first information on a protocol data unit (PDU) set associated with quality of service (QoS) parameters;
receiving, from the second node, a handover request acknowledge message;
identifying whether second information indicating support of a PDU set based handling is included in the handover acknowledge message; and
in case that the second information indicating the support of the PDU set based handling is included in the handover acknowledge message, generating a data to be forwarded including third information on the PDU set.

2. The method of claim 1,
wherein the first information comprises PDU set QoS parameters information element,
wherein the second information comprises PDU set based handling indicator information element, and
wherein the third information comprises PDU set information container.

3. The method of claim 1, further comprising:
transmitting, to the second node, the data with the third information on the PDU set.

4. The method of claim 1, wherein the second information is transmitted by the second node to an access and mobility management function (AMF).

5. A method performed by a second node in a wireless communication system, the method comprising:
receiving, from a first node, a handover request message comprising first information on a protocol data unit (PDU) set associated with quality of service (QoS) parameters; and
transmitting, to the first node, a handover request acknowledge message,
wherein, in case that second information indicating support of a PDU set based handling is included in the handover acknowledge message, third information on the PDU set is included in a data to be forwarded by the first node.

6. The method of claim 5,
wherein the first information comprises PDU set QoS parameters information element,
wherein the second information comprises PDU set based handling indicator information element, and
wherein the third information comprises PDU set information container.

7. The method of claim 5, further comprising:
receiving, from the first node, the data with the third information on the PDU set, and
transmitting, to an access and mobility management function (AMF), the second information.

8. A first node in a wireless communication system, the first node comprising:
a transceiver; and
at least one processor coupled with the transceiver and configured to:
transmit, to a second node, a handover request message comprising first information on a protocol data unit (PDU) set associated with quality of service (QoS) parameters,
receive, from the second node, a handover request acknowledge message,
identify whether second information indicating support of a PDU set based handling is included in the handover acknowledge message, and
in case that the second information indicating the support of the PDU set based handling is included in the handover acknowledge message, generate a data to be forwarded including third information on the PDU set.

9. The first node of claim 8,
wherein the first information comprises PDU set QoS parameters information element,
wherein the second information comprises PDU set based handling indicator information element, and
wherein the third information comprises PDU set information container.

10. The first node of claim 8, wherein the at least one processor is further configured to:
transmit, to the second node, the data with the third information on the PDU set.

11. The first node of claim 8, wherein the second information is transmitted by the second node to an access and mobility management function (AMF).

12. A second node in a wireless communication system, the second node comprising:
a transceiver; and
at least one processor coupled with the transceiver and configured to:
receive, from a first node, a handover request message comprising first information on a protocol data unit (PDU) set associated with quality of service (QoS) parameters, and
transmit, to the first node, a handover request acknowledge message,
wherein, in case that second information indicating support of a PDU set based handling is included in the handover acknowledge message, third information on the PDU set is included in a data to be forwarded by the first node.

13. The second node of claim 12,
wherein the first information comprises PDU set QoS parameters information element,
wherein the second information comprises PDU set based handling indicator information element, and
wherein the third information comprises PDU set information container.

14. The second node of claim 12, wherein the at least one processor is further configured to:
receive, from the first node, the data with the third information on the PDU set.

15. The second node of claim 12, wherein the at least one processor is further configured to:
transmit, to an access and mobility management function (AMF), the second information.
